(19) United States
(12) Patent Application Publication
(10) Pub. No.: US 2025/0193739 A1
(43) Pub. Date: Jun. 12, 2025

(54) INFORMATION ELEMENTS SUPPORT

(71) Applicant: TELEFONAKTIEBOLAGET LM ERICSSON (PUBL), Stockholm (SE)

(72) Inventors: Alexander Vesely VESELY, FELDBACH (AT); Nianshan SHI, JÄRFÄLLA (SE); Mohammed Yazid LYAZIDI, London (GB); Luca LUNARDI, GENOVA (IT); Filip BARAC, Huddinge (SE); Angelo CENTONZA, GRANADA (ES)

(73) Assignee: TELEFONAKTIEBOLAGET LM ERICSSON (PUBL), Stockholm (SE)

(21) Appl. No.: 18/856,498

(22) PCT Filed: Apr. 13, 2023
(86) PCT No.: PCT/SE2023/050341

§ 371 Date: Oct. 11, 2024

Related U.S. Application Data
(60) Provisional application No. 63/362,967, filed on Apr. 14, 2022.

(51) Int. Cl. H04W 28/18; H04W 92/02

(52) U.S. Cl. CPC H04W 28/18; H04W 92/02

(57) ABSTRACT

A method performed by a first Radio Access Network. RAN node is provided. The method is for handling supported Information Elements (IEs) related to a procedure involving a number of network nodes, towards a second RAN node in a wireless communications system. The first RAN node sends (301) a first indication towards the second RAN node. The first indication indicates whether or not one or more first IEs, that are part of the procedure are supported by the first RAN node during the procedure. The first RAN node receives (302) a response comprising a second indication from the second RAN node. The second indication indicates whether or not one or more second IEs that are part of the procedure are supported by the second RAN node during the procedure.

### TECHNICAL FIELD

Embodiments herein relate to radio access nodes, core network nodes and methods therein. In some aspects, they relate to handling supported Information Elements (IEs) related to a procedure involving a number of network nodes in a wireless communications system.

### BACKGROUND

In a typical wireless communication network, wireless devices, also known as wireless communication devices, mobile stations, stations (STA) and/or User Equipments (UE) s, communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in Fifth Generation (5G) telecommunications. A service area or cell area is a geographical area where radio coverage is provided by the radio network node. The radio network node communicates over an air interface operating on radio frequencies with the wireless device within range of the radio network node.

3GPP is the standardization body for specify the standards for the cellular system evolution, e.g., including 3G, 4G, 5G and the future evolutions. Specifications for the Evolved Packet System (EPS), also called a Fourth Generation (4G) network, have been completed within the 3rd Generation Partnership Project (3GPP). As a continued network evolution, the new releases of 3GPP specifies a 5G network also referred to as 5G New Radio (NR).

Frequency bands for 5G NR are being separated into two different frequency ranges, Frequency Range 1 (FR1) and Frequency Range 2 (FR2). FR1 comprises sub-6 GHz frequency bands. Some of these bands are bands traditionally used by legacy standards but have been extended to cover potential new spectrum offerings from 410 MHz to 7125 MHz FR2 comprises frequency bands from 24.25 GHz to 52.6 GHZ. Bands in this millimeter wave range have shorter range but higher available bandwidth than bands in the FR1.

Multi-antenna techniques may significantly increase the data rates and reliability of a wireless communication system. For a wireless connection between a single user, such as UE, and a base station, the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques is used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may benefit when each UE only has one antenna. Such systems and/or related techniques are commonly referred to as MIMO.

3GPP has since Release 99 introduced in Application Protocols specifying open network interfaces, such as NG Application Protocol (NGAP), S1AP, XnAP, etc., a mechanism by which a sender may control a receiver's behavior in case comprehension is critical to control.

Each Elementary Procedure (EP) and each Information Element (IE) contained within a message of an elementary procedure is assigned with a “criticality”, and there are 3 criticalities defined: “reject”, “ignore” and “ignore and notify”, whereas only “reject” and “ignore” have been used throughout 3G, 4G and 5G.

If a logical node receives an information element (IE) assigned with criticality “reject”, and if the logical node does not support the functionality associated to that information, the logical node will terminate the procedure unsuccessfully and notify the sending node about its non-support of that protocol element/EP by means of signaling an error message, independently of whether the node does not support functionalities for the whole procedure or only the information element (IE) with criticality “reject”.

The sending node may deduce,—from either the procedure code or the IE identifier received within the error message,—the protocol element that is not supported by the peer node and adapt future communication, by typically not triggering the procedure any more or not including the IE not supported by its peer node.

A procedure or IE associated with the criticality “ignore” however allows the receiving node to leave the sending node unaware of its non-support for the IE and continue to process the content of the message and execute the respective functions. In this case the receiving node will discard the IE that is not supported and with criticality “ignore”. Namely the functionalities associated to such IE will not be carried out by the receiving node.

The above mechanism aims to ensure interworking between peer nodes with different levels of feature implementation, ensuring backwards compatibility, meaning that a node deployed according to a “higher” version of a certain Application Protocol is able to operate together with a node deployed according to a “lower” version” of the same Application Protocol. The same mechanism also ensures forwards compatibility. Namely, if a new version of an AP supports a new IE and if such IE is marked with criticality ignore, then the receiving node, supporting an older version of the AP is able to discard the non-supported IE and continue functioning according to its supported functionalities. However, if the node supporting an older version of the AP receives an IE from a newer version of the AP, with criticality “reject”, the node will have to terminate the procedure and send back an error message, as explained above.

In principle, even the concept of “versions” disappears, and deployment may choose from a set of functions, irrespective the “3GPP Release”.

### SUMMARY

As a part of developing embodiments herein the inventors identified a problem which first will be discussed.

While Operations Administration and Maintenance (OAM) configuration and a homogenous feature deployment, namely aligning all nodes to support the same functionalities, is capable of solving most issues, an existing “criticality mechanism” works only on a single interface instance, where one node is “sitting”, also referred to as located, at each end of the interface. A criticality mechanism when used herein e.g. a mechanism to handle criticality information as set for individual IEs and/or IE groups as specified in 3GPP TS 38.413 v17.0.0.

If e.g., handover or dual connectivity is executed on an X2/Xn interface, the “criticality mechanism” works in the sense that procedures and IEs which are so important, that a certain feature would not work w/o the peer node supporting the function behind it, are assigned with a criticality set to “reject”, by which a node is able to gradually learn its peer's level of support. The X2 interface is a point-to-point logical interface between two eNodeBs. The Xn interface is an interface between two NG-RAN nodes.

For mobility however, involving multiple interface instances, i.e. handover that has to be performed via the CN, more than one interface instance of the RAN-CN interface are involved. One at the source side and one at the target side, and between CN nodes, e.g., when the source RAN node and the target RAN node are NG-RAN nodes connected to different Access and Mobility Management Functions (AMFs), or in case of inter-system mobility, where the source RAN node is an Evolved-UMTS Terrestrial Radio Access Network E-UTRAN node connected to EPC, and the target RAN node is an NG-RAN node, and AMF. In other words, the criticality mechanism does not work in case the functionality, e.g., handover, and the signaling procedures associated to it, involve more than two network nodes. One example is NG-based handover, that involves 3 or more network nodes.

In total, as far as RAN3 defined Application Protocols are concerned, up to 4 nodes may be involved, source and target RAN node and source and target CN node; each of them with potentially different levels of support. It needs to be pointed out that each RAN node may be split into different nodes. For example, a gNB in a split RAN architecture may consist of, also referred to as comprise, a gNB-Central Unit (CU) User Plane (UP), a gNB-CU-Control Plane (CP) and a gNB-Distributed Unit (DU). In a procedure such as the handover, each of these split RAN nodes is in charge of a functionality, which if not supported may cause the failure of the handover procedure. An example of such an architecture is illustrated in FIG. 1, e.g., which illustrates mobility involving Core Network nodes.

The problem is therefore how to enable that different nodes involved in supporting the functionalities and the signaling associated with a certain feature are aware that the functionality and signaling is supported in full by all nodes involved. If the functionalities and the signaling are not supported by at least one of the second RAN node or the first CN node serving the first RAN node or the second CN node serving the second RAN node, then performing (or executing) a procedure and/or a functionality, the procedure and/or functionality initiated by a first RAN node served by a first CN node, and involving a second RAN node served by a second CN node, would result in a failure and/or in an undefined outcome—for instance, whether it is appropriate/possible for the first RAN node to attempt in the future the same procedure and/or functionality towards the second RAN node. The first RAN node is left with no knowledge about the support of the procedure and/or functionality at any of the second RAN node and/or first CN node and/or second CN node. There is no mechanism to support the first RAN node in avoiding to reattempt executing the same procedure and/or functionality multiple times in the future, leading to more failures and/or undefined behavior. If the functionalities and the signaling are not supported, an effect is then also a waste of signaling, manifested in the path between the first RAN node and the second RAN node, and including the CN signaling between the first CN node serving the first RAN node and the second CN node serving the second RAN node.

In the specific example of handovers via the CN, it is not possible at the source RAN to understand if the full functionality associated with a CN based Handover (HO) procedure is supported by target RAN or target AMF.

Similarly, the source RAN node does not know about support at target CN node or at target RAN node for a function using certain IEs that would be signaled to modify a session context that has already been established between the source and the target.

An object of embodiments herein is to improve efficiency of a wireless communications network.

According to an aspect, the object is achieved by a method performed by a first Radio Access Network, RAN node. The method is for handling supported Information Elements, IEs, related to a procedure involving a number of network nodes, towards a second RAN node in a wireless communications system.

The first RAN node sends a first indication towards the second RAN node. The first indication indicates whether or not one or more first IEs, that are part of the procedure are supported by the first RAN node during the procedure.

The first RAN node receives a response comprising a second indication from the second RAN node. The second indication indicates whether or not one or more second IEs that are part of the procedure are supported by the second RAN node during the procedure.

According to an aspect, the object is achieved by a method performed by a second Radio Access Network, RAN node. The method is for handling supported Information Elements, IEs, related to a procedure involving a number of network nodes, from a first RAN node towards the second RAN node in a wireless communications system.

The second RAN node receives a first indication from the first RAN node. The first indication indicates whether or not one or more first IEs, that are part of the procedure are supported by the first RAN node during the procedure.

The second RAN node sends a response comprising a second indication towards the first RAN node. The second indication indicates whether or not one or more second IEs that are part of the procedure are supported by the second RAN node during the procedure.

According to an aspect, the object is achieved by a method performed by a first Core Network, CN, node. The method is for handling supported Information Elements, IEs, related to a procedure involving a number of network nodes, from a first Radio Access Network, RAN, node towards a second RAN node in a wireless communications system. The first CN node is serving the first RAN node.

The first CN node receives a first indication from the first RAN node, sent towards the second RAN node. The first indication indicates whether or not one or more first IEs, that are part of the procedure are supported by the first RAN node during the procedure.

The first CN node filters the one or more first IEs comprised in the first indication based on whether the one or more first IEs are supported by the first CN node.

The first CN node sends towards the second RAN node, the first indication as filtered. The first indication as filtered indicates whether or not one or more first IEs that are part of the procedure are supported by both the first RAN node and the first CN node during the procedure.

According to an aspect, the object is achieved by a method performed by a second Core Network, CN, node. The method is for handling supported Information Elements, IEs, related to a procedure involving a number of network nodes, from a first Radio Access Network, RAN, node towards a second RAN node in a wireless communications system. The second CN node is serving the second RAN node.

The second CN node receives from the first RAN node sent towards the second RAN node via a first CN node serving the first RAN node, a first indication as first filtered by the first CN node. The first indication as first filtered indicates whether or not one or more first IEs that are part of the procedure are supported by both the first RAN node and the first CN node during the procedure.

The second CN node further filters the one or more first IEs comprised in the received first indication as first filtered, based on whether the one or more first IEs are supported by the second CN node.

The second CN node sends towards the second RAN node, the first indication as further filtered by the second CN node, indicating whether or not the one or more first IEs are supported by the first RAN node, the first CN node and the second CN node, during the procedure.

According to another aspect, the object is achieved by a first Radio Access Network, RAN node. The first RAN node is configured to handle supported Information Elements, IEs, related to a procedure involving a number of network nodes, towards a second RAN node in a wireless communications system. The first RAN node is further configured to:
Send a first indication towards the second RAN node, which first indication is adapted to indicate whether or not one or more first IEs, that are part of the procedure are supported by the first RAN node during the procedure, anfd
receive a response comprising a second indication from the second RAN node, which second indication is adapted to indicate whether or not one or more second IEs that are part of the procedure are supported by the second RAN node during the procedure.

According to another aspect, the object is achieved by a second Radio Access Network, RAN node. The second RAN node is configured to handle supported Information Elements, IEs, related to a procedure involving a number of network nodes, from a first RAN node towards the second RAN node in a wireless communications system. The second RAN node is further configured to:
Receive a first indication from the first RAN node, which first indication is adapted to indicate whether or not one or more first IEs, that are part of the procedure are supported by the first RAN node during the procedure, and
send a response comprising a second indication towards the first RAN node, which second indication is adapted to indicate whether or not one or more second IEs that are part of the procedure are supported by the second RAN node during the procedure.

According to another aspect, the object is achieved by a first Core Network, CN, node. The first CN node is configured to handle supported Information Elements, IEs, related to a procedure involving a number of network nodes, from a first Radio Access Network, RAN, node towards a second RAN node in a wireless communications system. The first CN node is serving the first RAN node. The first CN node is further configured to:
Receive a first indication from the first RAN node sent towards the second RAN node, which first indication is adapted to indicate whether or not one or more first IEs, that are part of the procedure are supported by the first RAN node during the procedure,
filter the one or more first IEs comprised in the first indication based on whether the one or more first IEs are supported by the first CN node, and
send towards the second RAN node the first indication as filtered, which first indication as filtered is adapted to indicate whether or not one or more first IEs that are part of the procedure are supported by both the first RAN node and the first CN node during the procedure.

According to another aspect, the object is achieved by a second Core Network, CN, node. The second CN node is configured to handling supported Information Elements, IEs, related to a procedure involving a number of network nodes, from a first Radio Access Network, RAN, node towards a second RAN node in a wireless communications system. The second CN node is serving the second RAN node. The second CN node is further configured to:

Receive from the first RAN node, sent towards the second RAN node via the first CN node serving the first RAN node, a first indication as first filtered by the first CN node, which first indication as first filtered is adapted to indicate whether or not one or more first IEs that are part of the procedure are supported by both the first RAN node and the first CN node during the procedure,
further filter the one or more first IEs comprised in the received first indication as first filtered based on whether the one or more first IEs are supported by the second CN node, and
send towards the second RAN node, the first indication as further filtered by the second CN node indicating whether or not the one or more first IEs are supported by the first RAN node, the first CN node and the second CN node, during the procedure.

An advantage of embodiments herein is e.g., that they enable gaining knowledge of protocol support at all involved logical network nodes and network functions such as RAN nodes, functions of a RAN node deployed in split architecture such as e.g., gNB-CU-CPs, gNB-CU-UPs, gNB-DUs, and CN nodes, for any procedure and functionality that involves more than two logical network nodes and/or network functions.

A further advantage of embodiments herein is e.g., that introducing a per-feature basis “support” indicator over network interfaces is avoided, which would otherwise lead to explicitly revealing the status of supported functionalities for nodes involved in a procedure.

### BRIEF DESCRIPTION OF THE DRAWINGS

FIG. 1 is a schematic diagram depicting prior art.

FIG. 2 is a schematic block diagram depicting embodiments of a wireless communications system.

FIG. 3 is a flow chart depicting embodiments of a method performed by a first RAN node.

FIG. 4 is a flow chart depicting embodiments of a method performed by a second RAN node.

FIG. 5 is a flow chart depicting embodiments of a method performed by a first CN node.

FIG. 6 is a flow chart depicting embodiments of a method performed by a second CN node.

FIG. 7 is a schematic block diagram depicting embodiments of a wireless communications system.

FIG. 8 is a sequence diagram depicting embodiments of a method.

FIG. 9 a and b are schematic block diagrams depicting embodiments of a method performed by a first RAN node.

FIG. 10 a and b are schematic block diagrams depicting embodiments of a method performed by a second RAN node.

FIGS. 11a and b are schematic block diagrams depicting embodiments of a method performed by a first CN node.

FIG. 12 a and b are schematic block diagrams depicting embodiments of a method performed by a second CN node.

FIG. 13 schematically illustrates a telecommunication network connected via an intermediate network to a host computer.

FIG. 14 is a generalized block diagram of a host computer communicating via a base station with a user equipment over a partially wireless connection.

FIGS. 15 to 18 are flowcharts illustrating methods implemented in a communication system including a host computer, a base station and a user equipment.

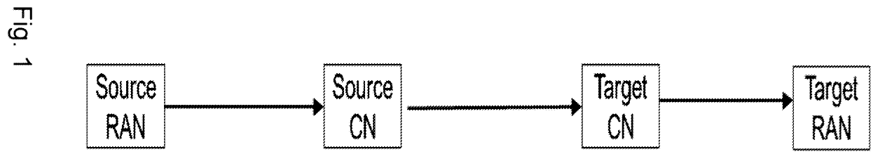

### DETAILED DESCRIPTION

Embodiments herein provide a mechanism in the form of methods and nodes for exchanging indications indicating node's capabilities to support IEs and optionally functionalities associated with the respective supported IEs during a given procedure, also referred to as information of the supported IE-Id during a given procedure, for example during a HO Resource Allocation procedure, based on the peer nodes' understanding of IE-Ids from different systems. This mechanism according to embodiments herein may be generalized for NGAP and S1AP, and for inter-system mobility, including via F1AP. The mechanism according to embodiments herein, will not necessarily be dependent on the criticality assigned to a certain IE, but the peer-RAN node would have to take into account its serving CN node support which is typically dependent on the assigned criticality.

The indications may be referred to as data. The IEs, may e.g., be IE-IDs.

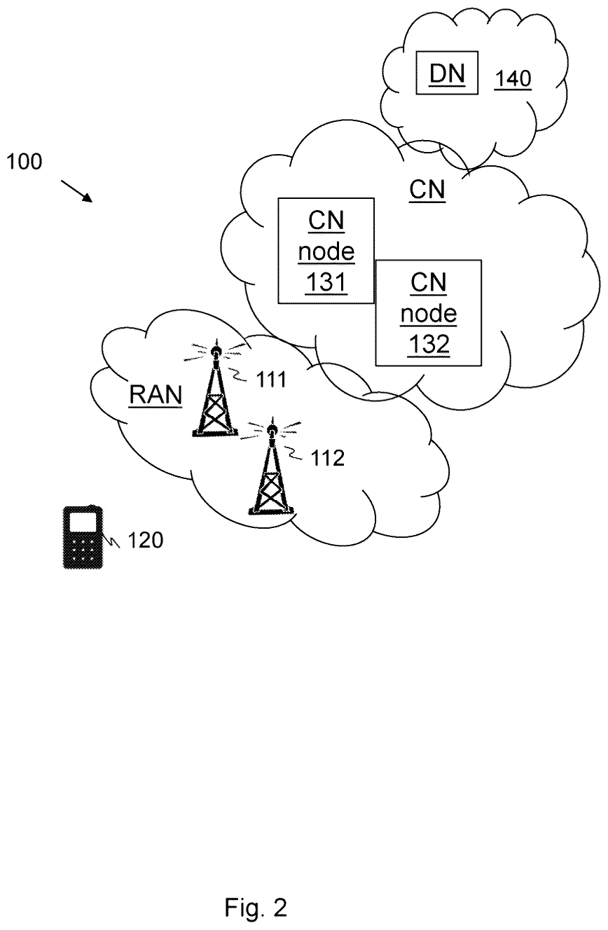

FIG. 2 is a schematic overview depicting a wireless communications network 100 wherein embodiments herein may be implemented. The wireless communications network 100 comprises one or more RANs and one or more CNs. The wireless communications network 100 may use 5G NR but may further use a number of other different technologies, such as, Wi-Fi, (LTE), LTE-Advanced, Wideband Code Division Multiple Access (WCDMA), Global System for Mobile communications/enhanced Data rate for GSM Evolution (GSM/EDGE), or Ultra Mobile Broadband (UMB), just to mention a few possible implementations.

RAN nodes, such as a first RAN node 111 and a second RAN node 112 operate in the wireless communications network 100. The first RAN node 111 and/or the second RAN node 112, may respectively be an Access Point (AP) and e.g., provides a number of cells, and may use these cells for communicating with UEs, e.g., a UE 120. The first RAN node 111 and/or the second RAN node 112 may respectively be a transmission and reception point e.g., a radio access network node such as a base station, e.g., a radio base station such as a NodeB, an evolved Node B (eNB, eNodeB, eNode B), an NR Node B (gNB), a base transceiver station, a radio remote unit, an Access Point Base Station, a base station router, a transmission arrangement of a radio base station, a stand-alone access point, a Wireless Local Area Network (WLAN) access point, an Access Point Station (AP STA), an access controller, a UE acting as an access point or a peer in a Device to Device (D2D) communication, or any other suitable networking unit. The first RAN node 111 and/or the second RAN node 112, may respectively e.g., further be able to communicate with each other via one or more CN nodes in the wireless communications network 100.

It should be noted that the first RAN node 111 and/or the second RAN node 112, may e.g., be split into different nodes. For example, a RAN node 111, 112 such as a gNB in a split RAN architecture may comprise a gNB-CU-UP, a gNB-CU-CP and a gNB-DU.

User Equipments operate in the wireless communications network 100, such as a UE 120. The UE 120 may e.g., be an NR device, a mobile station, a wireless terminal, an NB-IoT device, an eMTC device, an NR RedCap device, a CAT-M device, a Wi-Fi device, an LTE device and a non-access point (non-AP) STA, a STA, that communicates via a base station such as e.g., the first RAN node 111 and/or the second RAN node 112. It should be understood by the skilled in the art that the UE relates to a non-limiting term which means any UE, terminal, wireless communication terminal, user equipment, (D2D) terminal, or node e.g., smart phone, laptop, mobile phone, sensor, relay, mobile tablets or even a small base station communicating within a cell.

CN nodes such as a first CN node 131 and/or a second CN node 132 operate in the wireless communications network 100. The CN node may e.g., be an AMF node, an MME node, or an SMF node. Each of the first CN node 131 and/or the second CN node 132 may be able to forwards messages and/or signals from/to any one or both of the first RAN node 111 and the second RAN node 112.

Methods herein may be performed by any one or more out of the first RAN node 111, the second RAN node 112, the first CN node 131, and the second CN node 132. As an alternative, a Distributed Node (DN) and functionality, e.g., comprised in a cloud 140 as shown in FIG. 2, may be used for performing or partly performing the methods of embodiments herein.

Embodiments herein may relate to a RAN node 111, 112 capability exchange e.g., at a CN based handover.

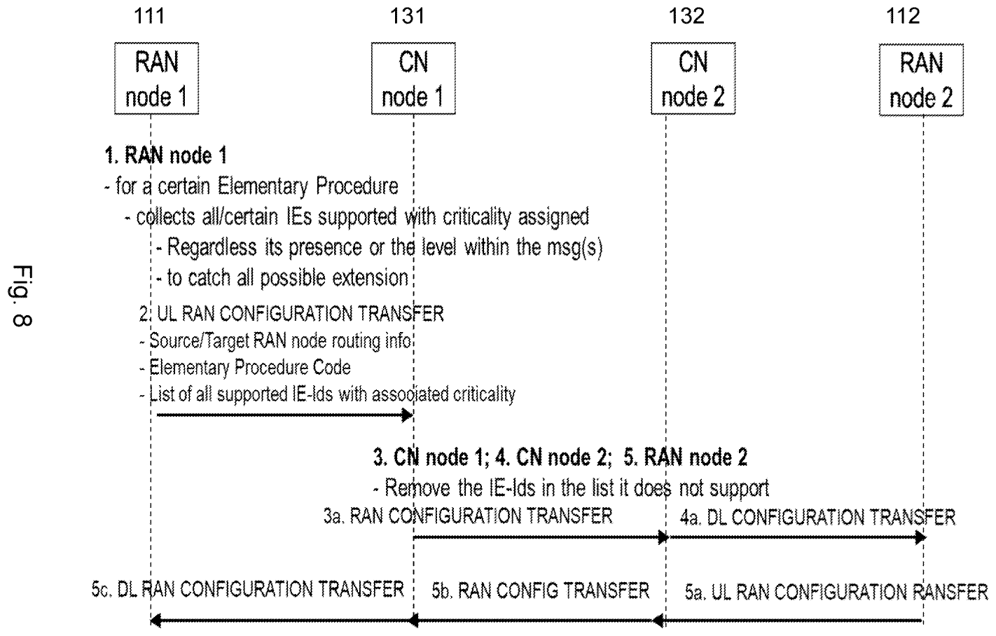

The procedure involving a number of network nodes, towards the second RAN node 112 may e.g., be performed via the first CN node 131, and the second CN node 132. In some embodiments, e.g., relating to Solution 2, see also FIG. 8 as described below, when the first indication is sent towards the second RAN node 112 it may first pass in the first CN node 131 and be filtered there such that the supported IEs comprises the IEs supported by both the first RAN node 111 and the first CN node 131. The filtered first indication may then be forwarded and passed to the second CN node 132 and be filtered there such that the supported IEs comprises the IEs supported by both the first RAN node 111, the first CN node 131 and the second CN node 132, before forwarding the further filtered first indication to the second RAN node 112. In this way, the further filtered first indication now teaches only IEs and optionally functionalities associated with the respective supported IEs that are supported by all involved nodes in the procedure.

The filtering e.g., means that IEs that are not supported by the respective filtering node are removed from the first indication before forwarding it to the next node.

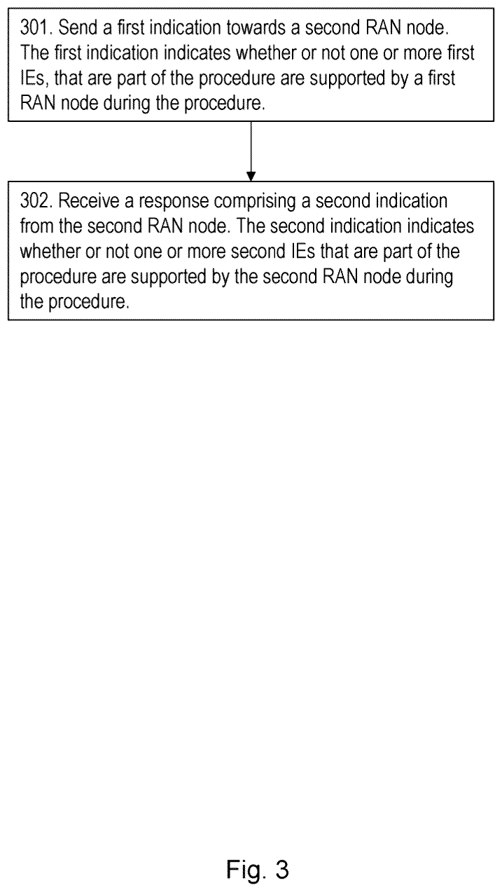

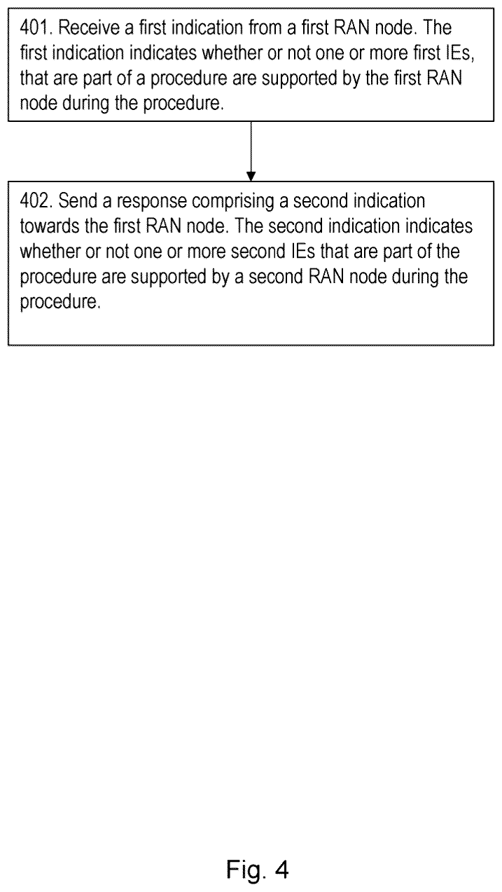

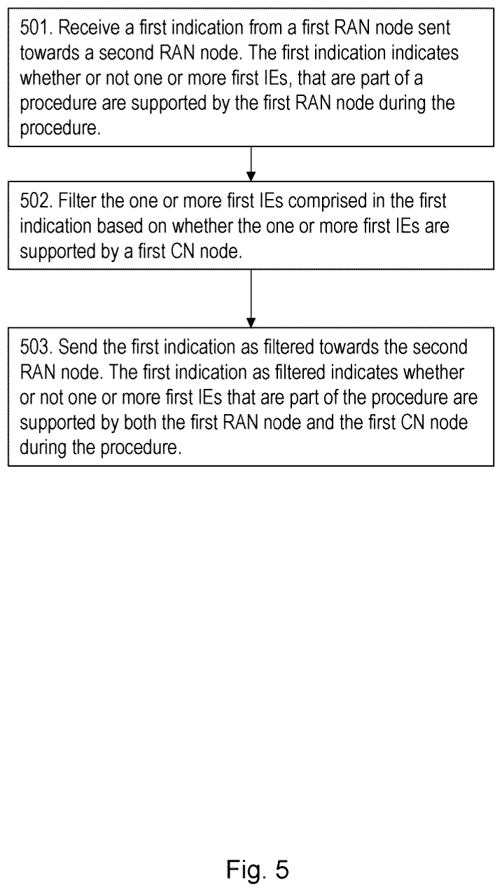

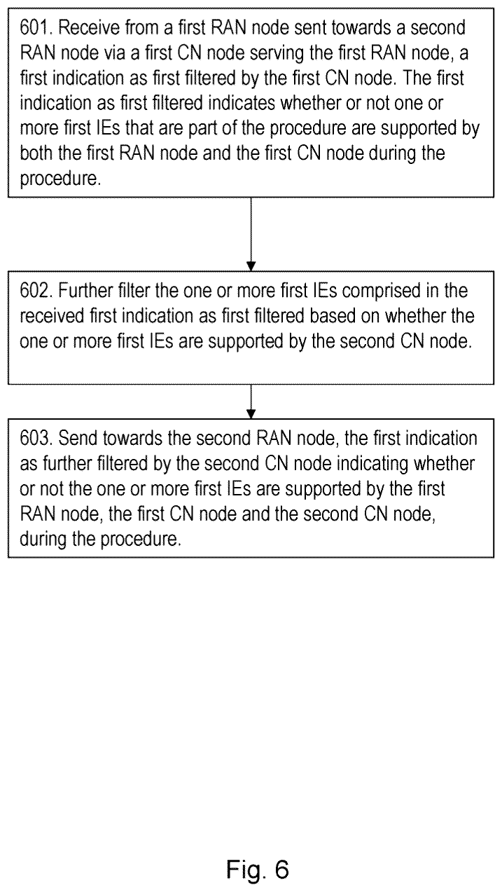

Embodiments of methods will now be described from different views, one by one, of the different involved nodes, comprising the first RAN node 111 in relation to FIG. 3, the second RAN node 112 in relation to FIG. 4, the first CN node 131 in relation to FIG. 5, and the second CN node 132 in relation to FIG. 6.

FIG. 3 shows an example method performed by the first RAN node 111. The method is for handling supported IEs, e.g., supported IE Identifiers (ID) s, related to a procedure involving a number of network nodes, towards the second RAN node 112 in a wireless communications system 100. The procedure may e.g. relate to a HO Resource Allocation procedure. The procedure involving a number of network nodes towards the second RAN node 112 may e.g., or involve also referred to as be performed via, the first CN node 131 serving the first RAN node 111, and the second CN node 132 serving the second RAN node 112. The method comprises any one or more out of the actions listed below.

### Action 301

The first RAN node 111 sends a first indication towards the second RAN node 112. The first indication may be sent from the first RAN node 111 via the first CN node 131, the second CN node 132 to the second RAN node 112.

The first indication indicates whether or not one or more first IEs, that are part of the procedure, are supported by the first RAN node 111 during the procedure. This is an advantage since, the first RAN node 111 is enabled to request whether any one of the second RAN node 112 or CN nodes along the signaling path between the first RAN node 111 and the second RAN node 112 supports or do not support one or more of the first IEs

In some embodiments, the first indication further indicates whether or not one or more first functionalities associated with the respective one or more first les that are part of the procedure, are supported by the first RAN node 111 during the procedure. This is an advantage since, the first RAN node 111 is enabled to request whether any one of the second RAN node 112 or CN nodes along the signaling path between the first RAN node 111 and the second RAN node 112 support or do not support one or more functionalities associated with the respective one or more first IEs

In some embodiments, the first indication sent to the second RAN node 112, will be received by the second RAN node 112 as filtered based on whether one or more out of:
the one or more first IEs are supported by one or more intermediate nodes during the procedure, such as e.g., the first CN node 131 serving the first RAN node 111, and the second CN node 132 serving the second RAN node, and/or
the one or more first functionalities associated with the respective one or more first IEs, are supported by one or more intermediate nodes during the procedure, such as e.g., the first CN node 131 serving the first RAN node 111, and the second CN node 132 serving the second RAN node.

### Action 302

The first RAN node 111 receives a response from the second RAN node 112. This is a response to the first indication sent towards the second RAN node 112. The response comprises a second indication. The second indication indicates whether or not one or more second IEs that are part of the procedure are supported by the second RAN node 112 during the procedure, and e.g., further supported by any one or more out of: the first CN node 131 serving the first RAN node 111, and the second CN node 132 serving the second RAN node 112 during the procedure. This is an advantage since, the first RAN node 111 obtains information on whether the second RAN node 112 and the CN nodes along the signaling path between the first RAN node 111 and the second RAN node 112 support or do not support one or more of the first IEs.

In some embodiments, the second indication further indicates whether or not one or more second functionalities associated with the respective one or more second IEs that are part of the procedure, are supported by the second RAN node 112 during the procedure, and e.g., further supported by any one or more out of: the first CN node 131 serving the first RAN node 111, and the second CN node 132 serving the second RAN node 112 during the procedure.

In some embodiments, the one or more second IEs are selected among the one or more first IEs.

In some embodiments, the one or more second functionalities are selected among the one or more first functionalities.

In this way, the first RAN node 111 obtains information on whether the second RAN node 112 and the CN nodes along the signaling path between the first RAN node 111 and the second RAN node 112 support or do not support one or more of the first IEs and/or whether the second RAN node 112 and the CN nodes along the signaling path between the first RAN node 111 and the second RAN node 112 support or do not support one or more first functionalities associated to the one or more first IEs.

FIG. 4 shows an example method performed by the second RAN node 112 for handling supported IEs, related to a procedure involving a number of network nodes, from the first RAN node 111 towards the second RAN node 112 in the wireless communications system 100, e.g., via the first CN node 131 serving the first RAN node 111 and the second CN node 132 serving the second RAN node 112. The method comprises any one or more out of the actions listed below.

### Action 401

The second RAN node 112 receives a first indication from the first RAN node 111. The first indication indicates whether or not one or more first IEs, that are part of the procedure are supported by the first RAN node 111 during the procedure.

In some embodiments, the first indication further indicates whether or not one or more first functionalities associated with the respective one or more first IEs that are part of the procedure, are supported by the first RAN node 111 during the procedure.

In some embodiments, the first indication received from the first RAN node 111, will be received as filtered based on whether one or more out of:
the one or more first IEs are supported by one or more intermediate nodes during the procedure, such as e.g., the first CN node 131 serving the first RAN node 111, and the second CN node 132 serving the second RAN node and/or
the one or more first functionalities associated with the respective one or more first IEs, are supported by one or more intermediate nodes during the procedure, such as e.g., the first CN node 131 serving the first RAN node 111, and the second CN node 132 serving the second RAN node.

As mentioned above, in some embodiments, when the first indication is sent towards the second RAN node 112 it may first pass in the first CN node 131 and be filtered there such that the supported IEs comprises the IEs supported by both the first RAN node 111 and the first CN node 131. The filtered first indication may then be forwarded and passed to the second CN node 132 and be filtered there such that the supported IEs comprises the IEs supported by both the first RAN node 111, the first CN node 131 and the second CN node 132, before forwarding the further filtered first indication to the second RAN node 112.

### Action 402

The second RAN node 112 sends a response comprising a second indication towards the first RAN node 111. This is a response to the first indication received from the first RAN node 111. The second indication indicates whether or not one or more second IEs that are part of the procedure are supported by the second RAN node 112 during the procedure, and e.g., further supported by any one or more out of: the first CN node 131 serving the first RAN node 111, the second CN node 132 serving the second RAN node 112 during the procedure.

In some embodiments, the second indication further indicates whether or not one or more second functionalities associated with the respective one or more second IEs that are part of the procedure, are supported by the second RAN node 112 during the procedure, and e.g., further supported by any one or more out of: a first CN node 131 serving the first RAN node 111, a second CN node 132 serving the second RAN node 112 during the procedure.

In some embodiments, the one or more second IEs are selected among the one or more first IEs.

In some embodiments, the one or more second functionalities are selected among the one or more first functionalities.

In this way the second RAN node 112, informs the first RAN node 111 of which one of the one or more first IEs and/or which one of the one or more first functionalities associated to the one or more first IEs are supported by the second RAN node 112 and by the first CN node 131 serving the first RAN node 111, and be the second CN node 132 serving the second RAN node112.

FIG. 5 shows an example method performed by the first CN node 131 for handling supported IEs related to a procedure involving a number of network nodes, from the first RAN node 111 towards the second RAN node 112 in the wireless communications system 100, e.g., via the first CN node 131 and the second CN node 132. The first CN node 131 is serving the first RAN node 111.

As mentioned above, in some embodiments, when the first indication is sent towards the second RAN node 112 it may first pass in the first CN node 131 and be filtered there such that the supported IEs comprises the IEs supported by both the first RAN node 111and the first CN node 131. The filtered first indication may then be forwarded and pass in the second CN node 132 for further filtering before forwarding the further filtered first indication to the second RAN node 112.

The method comprises any one or more out of the actions listed below.

### Action 501

The first CN node 131 receives a first indication from the first RAN node 111 sent towards the second RAN node 112. The first indication indicates whether or not one or more first IEs, that are part of the procedure are supported by the first RAN node 111 during the procedure.

In some embodiments, the first indication further indicates whether or not one or more first functionalities associated with the respective one or more first IEs that are part of the procedure, are supported by the first RAN node 111 during the procedure.

### Action 502

The first CN node 131 filters the one or more first IEs comprised in the first indication based on whether the one or more first IEs are supported by the first CN node 131.

In some embodiments, the first CN node 131 further filters the one or more first functionalities comprised in the first indication based on whether the one or more first functionalities are supported by the first CN node 131.

### Action 503

The first CN node 131 sends the first indication as filtered towards the second RAN node 112. The first indication as filtered indicates whether or not one or more first IEs that are part of the procedure are supported by both the first RAN node 111 and the first CN node 131 during the procedure.

In some embodiments, the first indication as filtered indicates whether or not the one or more first functionalities associated with the respective one or more first IEs are supported by both the first RAN node 111 and the first CN node 131 during the procedure.

In this way, the first CN node 131 can provide information to the first RAN node-once the response arrives at the first RAN node—of whether the first CN node supports or does not support one or more first IEs and/or one or more of first functionalities associated with the respective one or more first IEs.

FIG. 6 shows an example method performed by the second CN node 132 for handling supported IEs related to a procedure involving a number of network nodes, from the first RAN node 111 towards the second RAN node 112 in a wireless communications system 100, e.g., via the first CN node 131 serving the first RAN node 111 and the second CN node 132 serving the second RAN node 112. The second CN node 132 is serving the second RAN node 112.

As mentioned above, in some embodiments, when the first indication is sent towards the second RAN node 112 it may first pass in the first CN node 131 and be filtered there such that the supported IEs comprises the IEs supported by both the first RAN node 111and the first CN node 131. The filtered first indication may then be forwarded and pass in the second CN node 132 for further filtering before forwarding the further filtered first indication to the second RAN node 112.

The method comprises any one or more out of the actions listed below.

### Action 601

The second CN node 132 receives a first indication as first filtered by the first CN node 131 from the first RAN node 111 sent towards the second RAN node 112 via the first CN node 131 serving the first RAN node 111. The first indication as first filtered indicates whether or not one or more first IEs that are part of the procedure are supported by both the first RAN node 111 and the first CN node 131 during the procedure.

In some embodiments, the first indication as first filtered further indicates whether or not one or more first functionalities associated with the respective one or more first IEs are supported by both the first RAN node 111 and the first CN node 131 during the procedure.

### Action 602

The second CN node 132 further filters the one or more first IEs comprised in the received first indication as first filtered based on whether the one or more first IEs are supported by the second CN node 132.

In some embodiments, the second CN node 132 further filters the one or more first IEs comprised in the received first indication as first filtered further based on whether the one or more first functionalities are supported by the second CN node 132.

### Action 603

The second CN node 132 sends the first indication as further filtered by the second CN node 132 towards the second RAN node 112. The first indication as further filtered by the second CN node 132 indicates whether or not the one or more first IEs are supported by the first RAN node 111, the first CN node 131 and the second CN node 132 during the procedure.

In some embodiments, the first indication as further filtered, as sent towards the second RAN node 112, indicates whether or not the one or more first functionalities associated with the respective one or more first IEs are supported by the first RAN node 112, the first CN node 131 and the second CN node 132, during the procedure.

In this way, the second CN node 132 may provide information to the first RAN node 111—once the response arrives at the first RAN node 111—of whether the second CN node 132 supports or does not support one or more first IEs and/or one or more of first functionalities associated with the respective one or more first IEs.

In this way the methods described above, as an entirely, allow gaining knowledge of protocol support at all involved logical network nodes and network functions, RAN nodes such as the first RAN node 111 and the second RAN node 112, functions of a RAN node deployed in split architecture, e.g., gNB-CU-CPs, gNB-CU-UPs, gNB-DUs, and CN nodes such as the first CN node 131 and the second CN node 132, for any procedure and functionality that involves more than two logical network nodes and/or network functions.

For example, a RAN node, such as the first RAN node 111 and/or the second RAN node 112, is enabled to derive whether a certain procedure or functionality involving more than two logical nodes and/or network functions can be used or not, or whether such procedure or functionality can be fully or partially exploited.

The methods described above also avoids introducing a per-feature basis “support” indicator over network interfaces, which would otherwise lead to explicitly revealing the status of supported functionalities for network nodes or network functions involved in a procedure.

The methods will now be further explained and exemplified in below embodiments. The embodiments may be combined in any suitable manner.

Examples of method embodiments described herein are based on the signaling of one or more, e.g., in a list, of supported IEs that are part of a procedure involving a number of network nodes. Each node involved in the procedure may signal, either before the procedure takes place or during the procedure, an indication, indicating e.g., in a list, of IEs that apply to the procedure and that are supported. It should be noted that the wordings “the one or more IEs” and “the list of IEs” are used interchangeably herein. In some embodiments, the indication, also referred to as information, about support of each IE may also be complemented with specifying whether the functionality associated with the IE is supported or not supported. In some other embodiments, an indication of support or not-support for one IE implies that the functionality for that IE is supported or not-supported. In some other embodiments, the indication of support or not-support for one IE implies that only the IE is supported and not necessarily the functionality associated to it.

The method as described above may be applied to multiple procedures involving more than one network nodes. However, independently of the procedure, the method e.g., provides enriched signaling between nodes involved, such as e.g., the first RAN node 111, the second RAN node 112, the first CN node 131 and the second CN node 132, in the procedure with information that could be expressed in this exemplary form. Underlined text in below tables relate to embodiments herein.

| | | | | | |
|---|---|---|---|---|---|
| IE-Id Information | | 0 . . . 1 | List of IE-Id | YES | ignore |
| List | | | supported by the | | |
| | | | source NG-RAN | | |
| | | | node | | |
| >IE-id Information | | 1 . . . | | | |
| Item | | <maxnoofIEIds> | | | |
| >>IE-ID | M | INTEGER(0 . . . 500, . . . ) | | | |

Or as an alternative in the following forms (these alternatives are shown in the examples below, but are reported here because they apply to any use case):

| | | | | | |
|---|---|---|---|---|---|
| IE-Id Information List | | 0 . . . 1 | List of IE-Id supported | YES | ignore |
| | | | by the target NG-RAN | | |
| | | | node | | |
| >IE-id Information Item | | 1 . . . <maxnoofIEIds> | | | |
| >>IE-ID | M | INTEGER(0 . . . 500, . . . ) | | | |
| >>Supported Functionality | O | ENUMERATED(supported, | It indicates whether | | |
| | | not-supported) | the functionality | | |
| | | | corresponding to the | | |
| | | | IE is supported or not | | |
| | | | supported | | |

In some embodiments, the one or more supported IEs e.g., the list of supported IEs, described above may be complemented in the following way:

The addition of the “Supported Functionality” indication gives the possibility to express, e.g., whether an IE is supported but the functionality associated to it is not supported. This may be useful in cases where the functionality has not been developed or implemented in a given node, but where the Access Point (AP) message encoding has been updated to support the IE.

In some other embodiments, the IE support indication may be in the form of a bitmap, where the value “1” indicates “IE supported”, while the value “0” indicates “IE not supported”.

In some embodiments, the IE support indication for “all” IEs (e.g., all IEs for all features in a Release) are indicated. In other variants, the IE support indication refers to all IEs of certain features or certain IEs of certain features. In this case, a node may signal a structure made of a list, where each item in the list consists of a feature and an indication of supported IEs for such feature. Namely, the information shown above may be modified as follows:

| | | | | | |
|---|---|---|---|---|---|
| IE-Id Information List | | 0 . . . 1 | List of IE-Id supported by the target | YES | ignore |
| | | | NG-RAN node | | |
| >IE-id Information Item | | 1 . . . <maxnoofIEIds> | | | |
| >>Feature ID | M | INTEGER(0 . . . 500, . . . ) | Each integer represents a specific | | |
| | | | feature | | |
| >>IEs Support | M | ENUMERATED(Not-Supported, | Value “Not Supported” indicates that | | |
| | | Supported, Partially supported | none of the IEs for the feature is | | |
| | | | supported. Value “Supported” indicates | | |
| | | | that all the IEs for this feature are | | |
| | | | supported. Value “Partially supported” | | |
| | | | indicates that some of the IEs for this | | |
| | | | feature are supported. | | |

In some embodiments, absence of a response indication, e.g., no IE-Id list from the target node, may be interpreted by the source node, such as e.g., the first RAN node 111, that this node is a legacy node that does not support the corresponding features or functions.

Some examples of how the method applies to specific procedures are described below.

### Some First Embodiments Referred to as Solution 1

In some general embodiments, the indication of whether or not one or more IEs, that are part of the procedure are supported, such as e.g., a list of supported IE-Id information, is optionally included in a Source to Target Transparent Container transmitted from the first RAN node 111, in this example the source RAN node also referred to as source node, to the second RAN node 112, in this example the target RAN node, also referred to as target node, during an HO procedure performed via the CN, such as e.g., via the first CN node 131 and the second CN node 132. The target node replies with a list of its supported IE-Ids e.g., in the Target to Source Transparent Container, which is an IE signalled from the target RAN to the source RAN.

In one specific embodiment, a list of supported IE-Id as specified by the Application Protocol used on the source side RAN-CN interface, e.g., S1AP (TS 36.413) in case of EPS, NGAP (TS 38.413 v17.0.0) in case of 5GS, is included at the source RAN node in an initiating message of the Handover Preparation (HANDOVER REQUIRED), e.g., in the existing Source NG-RAN to Target NG-RAN transparent container IE of this message, and provided to the target RAN node by means of the initiating message of the Handover Resource Allocation procedure, e.g., in the existing Source NG-RAN to Target NG-RAN transparent container. The target RAN Node replies by sending a Target NG-RAN to Source NG-RAN transparent container that comprises a list of IE-ids related to the function that it supports.

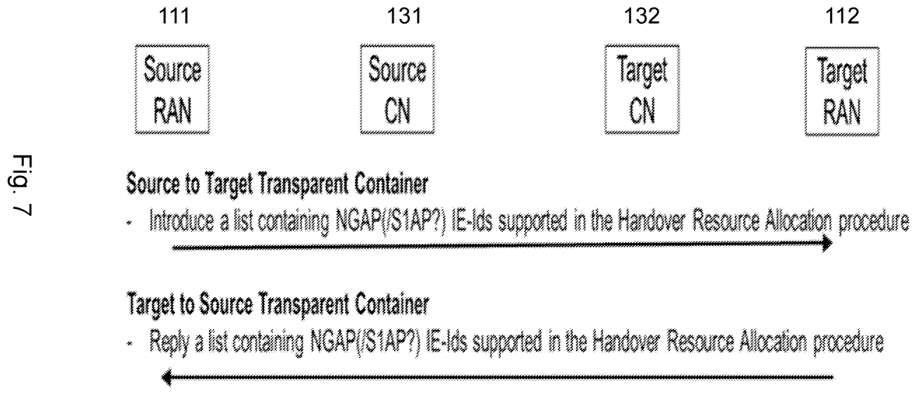

See FIG. 7 depicting Source to target Transparent Container and Target to Source Transparent Container in an example scenario wherein: The the first RAN node 111 is referred to as the Source RAN 111, the second RAN node 112 is referred to as the Target RAN 112, the first CN node 131 is referred to as the Source CN 131, and the second CN node 132 is referred to as the Target CN 132.

Instead of discussion on a per-feature basis whether a support indicator needs to be introduced, embodiments herein are generalised by specifying the exchange of supported IE Id of the HO resource Allocation procedures.

Embodiments herein may be introduced for NGAP and S1AP, even inter-system

Embodiments herein may e.g., only be applicable for the Handover resource Allocation Procedure.

Embodiments herein may e.g., only be for a limited number of IEs, it may not be intended to exchange the full set of IEs.

Embodiments herein may not necessarily be dependent on the criticality assigned to a certain IE, but the peer-RAN node would have to take into account its service CN such as e.g., the first CN node 131 and the second CN node 132.

Embodiments herein may e.g., replace out remote criticality for approach, or rather define it.

In some embodiments, the first RAN node 111, in this example the source RAN Node, may only include an IE-Id if also the serving CN node(s) 131 support the IE-Id. Respective knowledge may be gained by the CN node including the respective IE in a message, by means of the criticality mechanism, OAM or an explicit indication that the IE (or the related feature) is supported.

The second RAN node 112, in this example the target Node may reply that the feature is supported, if it has gained knowledge that also the serving CN 132 nodes support the feature. Respective knowledge on the target side may be gained as described above on the source side. If the target Node has not yet gained knowledge about the CN side support it may provide this information explicitly, e.g., “support not yet known”. If the target RAN node does not support the IE-Id, it shall reply “not supported” in any case.

In case of inter-system handover, the source RAN node may provide in the list of supported IE-Id those IE-Ids specified by the RAN-CN interface on the source side and may indicate the protocol supported on the source side RAN-CN interface explicitly. Likewise, the target RAN node may provide in the list of supported IE-Id those IE-Ids specified by the RAN-CN interface on the target side and may indicate the protocol supported on the target side RAN-CN interface explicitly, if the functional correspondence between IEs defined in RAN-CN interfaces specified for different systems is obvious or may be derived.

The list of IE-Ids does not need to be a comprehensive list of all IE-Ids supported, most typically it is a selective list. The target RAN node may only reply for those IEs for which support information was requested by the source RAN node.

The support information, i.e., the list of IE-Ids may also be provided within a Handover Failure Container in case the target node cannot successfully terminate the Handover Resource Allocation procedure.

If the source and target RAN configuration involves multiple nodes (e.g., in case of Dual- or Multi-Connectivity) the scope of the exchanged information may span over all involved RAN nodes, even if the control interface of the RAN-CN interface is only defined towards a single RAN node (as currently the case in EPS and 5GS), but this may depend on the feature represented by the IE-Id(s). In some embodiments, each new IE support indication supersedes the previous one. In some other embodiments, related to the update of IE support, only the difference with respect to the previous indication is sent.

In some embodiments, a node such as the first RAN node 111 or the second RAN node 112, indicate IE support only when polled. In some other embodiments, the first RAN node 111 may proactively indicate to the second RAN node 112, in this example the its IE support, where, in the response, the second RAN node 112, also indicates its IE support to the first RAN node 111.

A non-limiting example with added specification impact in underlined text is provided below:

3GPP TS 38.413 clause 9.3.1.29 Source NG-RAN Node to Target NG-RAN Node Transparent Container:

This IE is produced by the source NG-RAN node (e.g., the first RAN node 111), and is transmitted to the target NG-RAN node (e.g., the second RAN node 112). For inter-system handovers to 5G, the IE is transmitted from the external handover source to the target NG-RAN node.

This IE is transparent to the 5GC.

| | | | IE type | | | |
|---|---|---|---|---|---|---|
| | | | and | | | Assigned |
| IE/Group Name | Presence | Range | reference | Semantics description | Criticality | Criticality |
| RRC Container | M | | OCTET | Includes the RRC | — | |
| | | | STRING | HandoverPreparationInformation message | | |
| | | | | as defined in TS 38.331 [18] if the target is | | |
| | | | | a gNB. | | |
| | | | | Includes the RRC | | |
| | | | | HandoverPreparationInformation message | | |
| | | | | as defined in TS 36.331 [21] if the target is | | |
| | | | | an ng-eNB. | | |
| PDU Session | | 0 . . . 1 | | For intra-system handovers in NG-RAN. | — | |
| Resource | | | | | | |
| Information List | | | | | | |
| >PDU Session | | 1 . . . | | | — | |
| Resource | | <maxnoofPDUSessions> | | | | |
| Information | | | | | | |
| Item | | | | | | |
| >>PDU Session | M | | 9.3.1.50 | | — | |
| ID | | | | | | |
| >>QoS Flow | | 1 | | | — | |
| Information | | | | | | |
| List | | | | | | |
| >>>QoS Flow | | 1 . . . | | | — | |
| Information | | <maxnoofQoSFlows> | | | | |
| Item | | | | | | |
| . . . | | | | | | |
| >>>>QoS | M | | 9.3.1.51 | | — | |
| Flow Identifier | | | | | | |
| >>>>DL | O | | 9.3.1.33 | | — | |
| Forwarding | | | | | | |
| >>>>UL | O | | 9.3.1.118 | | YES | ignore |
| Forwarding | | | | | | |
| >>DRBs to QoS | O | | 9.3.1.34 | | — | |
| Flows Mapping | | | | | | |
| List | | | | | | |
| E-RAB | | 0 . . . 1 | | For inter-system handovers to 5G. | — | |
| Information List | | | | | | |
| >E-RAB | | 1 . . . | | | — | |
| Information | | <maxnoofE-RABs> | | | | |
| Item | | | | | | |
| >>E-RAB ID | M | | 9.3.2.3 | | — | |
| >>DL | O | | 9.3.1.33 | | — | |
| Forwarding | | | | | | |
| Target Cell ID | M | | NG-RAN | | — | |
| | | | CGI | | | |
| | | | 9.3.1.73 | | | |
| Index to | O | | 9.3.1.61 | | — | |
| RAT/Frequency | | | | | | |
| Selection Priority | | | | | | |
| UE History | M | | 9.3.1.95 | | — | |
| Information | | | | | | |
| SgNB UE X2AP | O | | 9.3.1.127 | Allocated at the Source en-gNB | — | |
| ID | | | | | | |
| UE History | O | | 9.3.1.166 | | YES | ignore |
| Information from | | | | | | |
| UE | | | | | | |
| IE-Id Information | | 0 . . . 1 | | List of IE-Id supported by the source NG- | YES | ignore |
| List | | | | RAN node | | |
| >IE-Id | | 1 . . . | | | | |
| Information Item | | <maxnoofIEIds> | | | | |
| >>IE-ID | M | INTEGER(0 . . . | | | | |
| | | 500, . . . ) | | | | |

| Range bound | Explanation |
|---|---|
| maxnoofPDUSessions | Maximum no. of PDU sessions allowed |
| | towards one UE. Value is 256. |
| maxnoofQoSFlows | Maximum no. of QoS flows allowed within |
| | one PDU session. Value is 64. |
| maxnoofE-RABs | Maximum no. of E-RABs allowed towards |
| | one UE. Value is 256. |
| maxnoofIEIds | Maximum no. of IE-Ids defined for the system. |
| | Value is N. |

3GPP TS 38.413 clause 9.3.1.30 Target NG-RAN Node to Source NG-RAN Node Transparent Container:

This IE is produced by the target NG-RAN node (e.g., the second RAN node 112) and is transmitted to the source NG-RAN node (e.g., the first RAN node 111). For inter-system handovers to 5G, the IE is transmitted from the target NG-RAN node to the external relocation source.

This IE is transparent to the 5GC.

| | | | IE type and | Semantics | | Assigned |
|---|---|---|---|---|---|---|
| IE/Group Name | Presence | Range | reference | description | Criticality | Criticality |
| RRC Container | M | | OCTET STRING | Includes the RRC | — | |
| | | | | HandoverCommand | | |
| | | | | message as defined in | | |
| | | | | TS 38.331 [18] if the | | |
| | | | | target is a gNB. | | |
| | | | | Includes the RRC | | |
| | | | | HandoverCommand | | |
| | | | | message as defined in | | |
| | | | | TS 36.331 [21] if the | | |
| | | | | target is an ng-eNB. | | |
| DAPS Response | | 0 . . . 1 | | | YES | ignore |
| Information List | | | | | | |
| >DAPS Response | | 1 . . . <maxnoofDRBs> | | | — | |
| Information Item | | | | | | |
| >>DRB ID | M | | 9.3.1.53 | | — | |
| >>DAPS Response | M | | 9.3.1.189 | Indicates the response | — | |
| Information | | | | to a requested DAPS | | |
| | | | | Handover | | |
| IE-Id Information List | | 0 . . . 1 | | List of IE-Id supported | YES | ignore |
| | | | | by the target NG-RAN | | |
| | | | | node | | |
| >IE-id Information | | 1 . . . <maxnoofIEIds> | | | | |
| Item | | | | | | |
| >>IE-ID | M | INTEGER(0 . . . 500, . . . ) | | | | |

| Range bound | Explanation |
|---|---|
| maxnoofDRBs | Maximum no. of DRBs allowed towards one UE. |
| | Value is 32. |
| maxnoofIEIds | Maximum no. of IE-Ids defined for the system. |
| | Value is N. |

In one embodiment, the list of supported IE-Id information is optionally signalled in the RAN Status Transfer Transparent Container for intra 5GC NG handover.

In one dependent embodiment, the list of supported IEs described above may be complemented in the following way:

| | | | | | |
|---|---|---|---|---|---|
| IE-Id Information List | | 0 . . . 1 | List of IE-Id supported by the | YES | ignore |
| | | | target NG-RAN node | | |
| >IE-id Information Item | | 1 . . . <maxnoofIEIds> | | | |
| >>IE-ID | M | INTEGER(0 . . . 500, . . . ) | | | |
| >>Supported | O | ENUMERATED(supported, | It indicates whether the | | |
| Functionality | | not-supported) | functionality corresponding to | | |
| | | | the IE is supported or not | | |
| | | | supported | | |

The addition of the “Supported Functionality” indication gives the possibility to express, e.g., whether an IE is supported but the functionality associated to it is not supported. This may be useful in cases where the functionality has not been developed or implemented in a given node, but where the AP message encoding has been updated to support the IE.

In some other embodiments, the IE support indication may be in the form of a bitmap, where the value “1” indicates “IE supported”, while the value “0” indicates “IE not supported”.

In some embodiments, the IE support indication for “all” IEs (e.g., all IEs for all features in a Release) are indicated. In another variant, the IE support indication refers to all IEs of certain features or certain IEs of certain features. In this case, a node such as e.g., the first RAN node 111, and the second RAN node 112, may signal a structure made of a list, where each item in the list comprises a feature and an indication of supported IEs for such feature. Namely, the information shown above may be modified as follows:

| | | | | | |
|---|---|---|---|---|---|
| IE-Id Information List | | 0 . . . 1 | List of IE-Id supported by the target NG-RAN | YES | Ignore |
| | | | node | | |
| >IE-id Information Item | | 1 . . . <maxnoofIEIds> | | | |
| >>Feature ID | M | INTEGER(0 . . . 500, . . . ) | Each integer represents a specific | | |
| | | | feature | | |
| >IEs Support | M | ENUMERATED(Not-Supported, | Value “Not Supported” indicates that | | |
| | | Supported, Partially supported | none of the IEs for the feature is supported. | | |
| | | | Value “Supported” indicates that all the IEs | | |
| | | | for this feature are supported. Value “Partially | | |
| | | | supported” indicates that some of the IEs for | | |
| | | | this feature are supported. | | |

### Some Second Embodiments Also Referred to as Solution 2

In these embodiments, a list of IE-Ids supported in each involved node, e.g., source/target RAN/CN node such as the first RAN node 111, the second RAN node 112, the first CN node 131 and the second CN node 132, is signalled irrespective of the assigned criticality, in a dedicated signalling procedure. Namely, to collect such information e.g., the RAN Configuration Transfer procedure(s) may be used-within one round-trip between source- and target RAN node, this info should be available at all involved RAN/CN nodes. The indication of supported/not-supported IEs may be achieved as in Solution 1, namely the different ways described above to represent support of IEs and their functionalities may be reused in these embodiments.

In one dependent embodiment, the IE support indication during a round trip traverses the involved RAN and CN nodes, such as e.g., the first RAN node 111, the second RAN node 112, the first CN node 131 and the second CN node 132, as shown in FIG. 8, where each node indicates e.g., by setting a flag, or, as exemplified, lists or indicates the IE such as the IE ID in the message accordingly. In this example the the first RAN node 111 is referred to as the RAN node 1 111, the second RAN node 112 is referred to as the RAN node 2 112, the first CN node 131 is referred to as the CN node 1 131, and the second CN node 132 is referred to as the CN node 2 132. For example, node X such as e.g., the first RAN node 111, lists an IE ID=5 (meaning that it supports the IE), and forwards the IE support indication to the next node in the chain, say node Y such as e.g., the first CN node 131. If node Y does not support the IE, it removes, also referred to as filters, the IE ID=5 from the list.

In some other embodiments, the IE support indication may be in the form of a bitmap, where the value “1” indicates “IE supported”, while the value “0” indicates “IE not supported”. In the context of solution 2, during the round trip of the IE indication across RAN and CN nodes, such as e.g., the first RAN node 111, the second RAN node 112, the first CN node 131 and the second CN node 132, as shown in FIG. 8, each node sets the bit in the bitmap corresponding to an IE support to “0” or “1”, depending on whether it supports the IE. In the example of FIG. 8, the existing UL/DL RAN Configuration Transfer is used to carry the IEs related to certain features.

A non-limiting example with added specification impact in underlined is provided below:

### 3GPP TS 38.413 Clause 9.2.7.1 UPLINK RAN CONFIGURATION TRANSFER

This message is sent by the NG-RAN node, (e.g., the first RAN node 111) in order to transfer RAN configuration information.

Direction: NG-RAN node→AMF (e.g., the first CN node 131),

| | | | IE type and | | | Assigned |
|---|---|---|---|---|---|---|
| IE/Group Name | Presence | Range | reference | Semantics description | Criticality | Criticality |
| Message Type | M | | 9.3.1.1 | | YES | ignore |
| SON Configuration | O | | 9.3.3.6 | | YES | ignore |
| Transfer | | | | | | |
| EN-DC SON | O | | OCTET | Contains the EN-DC SON | YES | ignore |
| Configuration Transfer | | | STRING | Configuration Transfer IE as | | |
| | | | | defined in TS 36.413 [16]. | | |
| Inter-system SON | O | | 9.3.3.33 | | YES | ignore |
| Configuration Transfer | | | | | | |
| IE-Id Information | | 0 . . . 1 | | List of IE-Id | YES | ignore |
| List | | | | supported | | |
| >IE-id Information | | 1 . . . | | | | |
| Item | | <maxnoofIEIds> | | | | |
| >>IE-ID | M | INTEGER(0 . . . 500, . . . ) | | | | |

| Range bound | Explanation |
|---|---|
| maxnoofIEIds | Maximum no. of IE-Ids defined for the system. |
| | Value is N. |

### 3GPP TS 38.413 Clause 9.2.7.2 DOWNLINK RAN CONFIGURATION TRANSFER

This message is sent by the AMF (e.g., the first CN node 131) in order to transfer RAN configuration information.

Direction: AMF→NG-RAN node (e.g., the first RAN node 111),

| | | | IE type and | | | Assigned |
|---|---|---|---|---|---|---|
| IE/Group Name | Presence | Range | reference | Semantics description | Criticality | Criticality |
| Message Type | M | | 9.3.1.1 | | YES | ignore |
| SON Configuration | O | | 9.3.3.6 | | YES | ignore |
| Transfer | | | | | | |
| EN-DC SON | O | | OCTET | Contains the EN-DC | YES | ignore |
| Configuration Transfer | | | STRING | SON Configuration | | |
| | | | | Transfer IE as defined in | | |
| | | | | TS 36.413 [16]. | | |
| Inter-system SON | O | | 9.3.3.33 | | YES | ignore |
| Configuration Transfer | | | | | | |
| IE-Id Information | | 0 . . . 1 | | List of IE-Id | YES | ignore |
| List | | | | supported | | |
| >IE-id Information | | 1 . . . | | | | |
| Item | | <maxnoofIEIds> | | | | |
| >>IE-ID | M | INTEGER(0 . . . 500, . . . ) | | | | |

| Range bound | Explanation |
|---|---|
| maxnoofIEIds | Maximum no. of IE-Ids defined for the system. |
| | Value is N. |

In some embodiments, the IE support indication for “all” IEs (e.g., all IEs for all features in a Release) are indicated. In another variant, the IE support indication refers to all IEs of certain features or certain IEs of certain features.

### Some Variants of the First Embodiments Referred to as Solution 1-a

For certain functionalities, e.g., related to Self-Organizing Networks (SON), two (or more) RAN nodes may be involved, with the first RAN node 111, in this example the a first (source) RAN node, being part of a first wireless communication system and/or a first RAT, and the second RAN node 112, in this example a second (target) RAN node pertaining to a second wireless communication system (and/or a second RAT). The functionality is fully (or partially) exploited when both the source RAN node and the target RAN node, and potentially the CN nodes in between, such as e.g., the first CN node 131 and the second CN node 132, fully (or partially) support the functionality in question. As part of the functionality operation, the source RAN node sends to the target RAN the first indication in this example a list of optionally supported IEs, conveyed transparently from the first RAN node to the second RAN node. The second RAN node replies with the second indication in this example a list of IE-Ids related to the functionality that it supports.
In one example, the functionality may be related to Energy Saving, the first RAN node 111 is an eNB (connected to EPC), and the second RAN node 112 is an gNB (connected to 5GC). The first RAN node 111 may requests and/or propose to the second RAN node 112 to switch off one or more cells or to switch off one or more SSB beams. The first indication e.g., indicating a list of optional IEs corresponding to the request and/or proposal to switch off certain cell(s) and/or SSB beam(s) is included in a transparent container. The methods used for handling the list of supported IE-Ids as they are signalled from the first RAN node 111 to the second RAN node 112 and back, may be the same as described for Solution 1 or for Solution 2. For example, the transparent container sent from the first RAN node 111 to the second RAN node 112 (or vice versa) as described in Solution 1 may be an extension of an Inter-system SON Configuration Transfer Type IE, or an extension of EN-DC SON Configuration Transfer SON Configuration Transfer IE.

In another scenario, a certain functionality, e.g., related to Self-Organizing Networks (SON), two RAN nodes are involved, and they both belongs to the same wireless communication system or the same RAT, and the functionality uses an indirect signaling connection between the RAN nodes. The functionality is fully exploited (or partially exploited) when both the first RAN node 111, in this example a source RAN node and the second RAN node 112, in this example the target RAN node, and potentially the CN nodes, such as e.g., the first CN node 131 and the second CN node 132, in between fully support (or partially support) the functionality in question. As part of the functionality operation, the source RAN node sends to the target RAN the first indication, in this example a list of optionally supported IEs, conveyed transparently from the first RAN node to the second RAN node. The second RAN node replies with the second indication, in this example a list of IE-Ids related to the functionality that it supports.
In one example, the functionality may relate to Energy Saving, where the first RAN node 111, in this example the first (source) NG-RAN node requests or proposes to the second RAN node 112, in this example the second (target) NG-RAN node to switch on or to switch off one or more cells or SSB beams of the second NG-RAN node, and the Xn link between the RAN nodes is not defined or is not available, or is temporarily not available. An indication such as a list of optional IEs corresponding to the request/proposal to switch on or to switch off certain cell(s) or to the request/proposal to switch on or to switch off certain SSB beam(s) may be included in a transparent container. The methods used for handling the list of supported IE-Ids as they are signalled from the first RAN node 111 to the second RAN node 112 and back, may be the same described for Solution 1 for Solution 2. For example, the transparent container sent from first RAN node 111 to second RAN node 112, as described in Solution 1 may be an extension of a Source to Target Transparent Container IE, or a SON Configuration Transfer IE, and the transparent container sent from the second RAN node 112 to the first RAN node 111 may be an extension of a Target to Source Transparent Container IE.

In another example, the functionality may relate to Cell Resource Coordination between nodes, in this example the first RAN node 111 is an gNB, the second RAN node 112 is a ng-eNB (or vice versa), and the Xn link between the RAN nodes is not defined or is not available or is temporarily not available. In one embodiment, the IE support indication for “all” IEs (e.g., all IEs for all functionalities in a Release) are indicated. In another embodiment, the IE support indication refers to all IEs of certain functionalities or certain IEs of certain functionalities.

### Some Third Embodiments Referred to as Solution 3—Methods Applied in Case of Multiple Receivers

The methods of embodiments herein may apply to the following scenarios:
The first RAN node 111, in this example a first (source) network node (or network function) sends a same type of request (or different type of requests) to two (or more) second RAN node 112, in this example two or more target RAN nodes (or network functions), wherein the request(s) may potentially go across other network nodes in between, e.g., CN nodes such as e.g., the first CN node 131 and the second CN node 132. The request(s) may comprise IE-Ids associated to the support of a certain functionality, and the IE-Ids may be signalled in one of the forms described in other embodiments (e.g., a list of IE-Ids, either the same list being sent to all the targets, or separate lists, or partially overlapping lists). The target network nodes (or functions) reply to the first network node. The first network node deduces the full or partial support of the functionality based on the replies. A failure in reply or a miss in reply from the second network node (or second network function) to the first network node (or first network function), e.g., due to a timer expiration, may be used by the first network node (or by the first network function) as an explicit or implicit indication of no support of the functionality at the second network node (or at second network function). The request comprises IE-Ids associated to the support of a certain functionality, and the IE-Ids may be signalled in one of the forms described in other embodiments. The second network node, based on the received requests and the received IE-Ids, sends a second request (which may comprise part of the first requests, e.g., forwards the received IE-Ids, potentially “filtered” based on second network node support of the functionality in question), to a third network node. The third network node based on the received requests and the received IE-Ids, sends the final response (which may comprise part of the first and second requests, e.g., the received IE-Ids, potentially “filtered” based on second network node and third network node support of the functionality in question), as the second indication, to the first network node. The first network node deduces the full or partial support of the functionality based on the response. A failure in response or a miss in response (e.g., due to a timer expiration) may be used as an explicit or implicit indication of no support of the functionality.
   Embodiments Related to NG-Based Mobility of gNB-DU

As mentioned above, the first RAN node 111, and the second RAN node 112, may be split RAN nodes. Previous embodiments focused on the indication of IE support for non-split RAN nodes (i.e., gNBs) or for CUs, by using the signalling for UE NG-based mobility. However, in Rel-18, the NG-based mobility of DUs, such as e.g., an IAB-DU, or any mobile DU, will likely be supported, whereas the indication of IE support between the mobile DU and the target CU becomes relevant.

In one embodiment, pertaining to the case of DU mobility (split RAN node assumed) and NG-based handover, the IE support indication refers to the IE support of the DU. In another embodiment, the IE support indication pertains to both the source CU and mobile DU.

In one dependent embodiment, pertaining to mobile Integrated Access and Backhauling (IAB) nodes, the DU's IE support is indicated as a part of handover signalling for the Integrated Access and Backhaul-Mobile Termination (IAB-MT) collocated with the DU. In another variant, a dedicated, enhanced existing or newly defined signalling is used, separately from the handover signalling for the IAB-MT.

In one dependent embodiment, the IE support pertaining to the IAB-DU, is indicated separately (e.g., using a separate dedicated message) separately for the IAB-DU of the first RAN node 111, in this example mobile IAB-node and the IAB-DUs of the descendants of the mobile IAB-node. In another sub-variant, the IE support is indicated together (e.g., using group signalling) for the IAB-DU of the mobile IAB-node and the IAB-DUs of its descendant IAB-DUs.

In one dependent embodiment pertaining to the above embodiments, the indication of IE support of the first RAN node 111, in this example the mobile DU uses source to target containers. In another variant, the indication of IE support of the first RAN node 111, in this example the mobile DU is sent explicitly over the interfaces, e.g., NG, S1, inter-AMF interface etc.

The embodiments presented in this chapter may use the encoding proposed by the previous chapters (i.e., the IE IDs), or they may use a different encoding.

The embodiments presented in this chapter may apply to mobile IAB-DUs or they may apply to mobile DUs (i.e., non-IAB DUs).

According to some embodiments herein a new approach is introduced to gain information on the level of support for a certain feature based on supported functionality at the target NG-RAN side associated with an NGAP IE based on the respective IE-Id. In the below example, the target NG-RAN, is represented by the second RAN node 112, the Source NG-RAN Node, is represented by the first RAN node 111.

These embodiments introduce the possibility to retrieve information, indicate such as the first indication and the second indication, on the level of support for a certain feature based on supported functionality at the target NG-RAN side, associated with an NGAP IE based on the respective IE-Id by means of information provided within the CN transparent handover containers.

In some embodiments, a new NGAP IE Support Information Request List IE is introduced in the Source NG-RAN Node, to Target NG-RAN Node, Transparent Container IE containing a list of NGAP Protocol IE-Ids, for which the target NG-RAN node shall provide support information e.g. according to the second indication, (“supported” or “not supported”) within either the Target NG-RAN Node, to Source NG-RAN Node Transparent Container IE or the Target NG-RAN Node, to Source NG-RAN Node Transparent Failure Transparent Container IE. In addition, information is provided whether the reported IE was actually received by the target NG-RAN node within an HANDOVER REQUEST message.

If the HANDOVER REQUEST message contains within the Source NG-RAN Node to Target NG-RAN Node Transparent Container IE the NGAP IE Support Information Request List IE, the target NG-RAN node shall, if supported and the target NG-RAN node accepts the request for handover, for each included NGAP Protocol IE-Id provide within in the Target NG-RAN Node to Source NG-RAN NodeTransparent Container IE in the HANDOVER REQUEST ACKNOWLEDGE message, e.g. according to the second indication,
set the NGAP Protocol IE Support Information IE to “supported” if the target NG-RAN node has information that the functionality associated with the indicated IE is supported
set the NGAP Protocol IE Support Information IE to “not-supported” if the target NG-RAN node has information that the functionality associated with the indicated IE is not supported on the interface instance via which the HANDOVER REQUEST message has been received, and
set the NGAP Protocol IE Presence Information IE to “present” if the target NG-RAN node has received the respective NGAP Protocol IE-Id in the HANDOVER REQUEST message, and “not-present” otherwise.

If the HANDOVER REQUEST message contains within the Source NG-RAN Node to Target NG-RAN Node Transparent Container IE the NGAP IE Support Information Request List IE, the target NG-RAN node shall, if supported and the target NG-RAN node does not accept the request for handover, for each included NGAP Protocol IE-Id provide within in the Target NG-RAN Node to Source NG-RAN Node Transparent Failure Transparent Container IE in the HANDOVER FAILURE message, e.g. according to the second indication,
set the NGAP Protocol IE Support Information IE to “supported” if the target NG-RAN node has information that the functionality associated with the indicated IE is supported
set the NGAP Protocol IE Support Information IE to “not-supported” if the target NG-RAN node has information that the functionality associated with the indicated IE is not supported on the interface instance via which the HANDOVER REQUEST message has been received, and
set the NGAP Protocol IE Presence Information IE to “present” if the target NG-RAN node has received the respective NGAP Protocol IE-Id in the HANDOVER REQUEST message, and “not-present” otherwise.

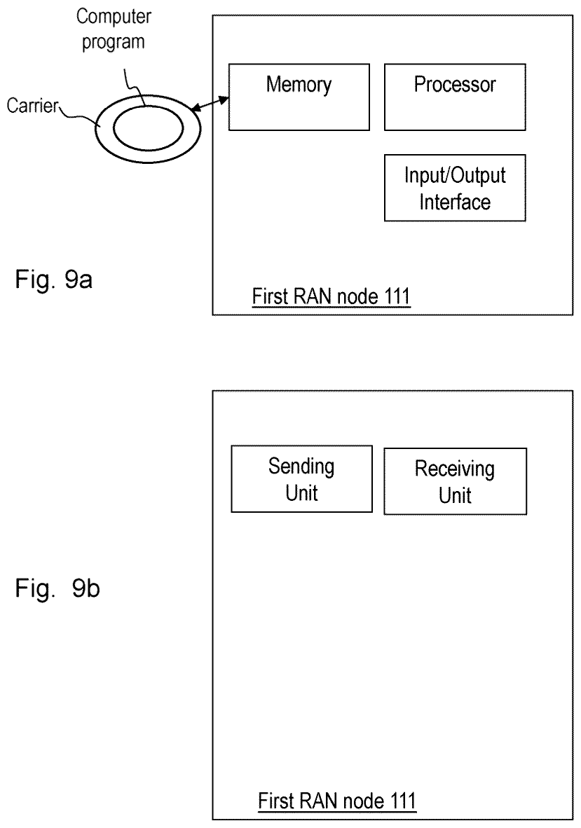

FIGS. 9a and 9b shows an example of arrangement in the first RAN node 111.

The first RAN node 111 may comprise an input and output interface configured to communicate with other networking entities in the wireless communications network 100, e.g., the second RAN node 112, the first CN node 131, and the second CN node 132. The input and output interface may comprise a receiver, e.g., wired and/or wireless, (not shown) and a transmitter, e.g., wired and/or wireless, (not shown).

The first RAN node 111 may comprise any one or more out of: An obtaining unit, a receiving unit to perform the method actions as described herein.

The embodiments herein may be implemented through a processor or one or more processors, such as at least one processor of a processing circuitry in the first RAN node 111 depicted in FIG. 9a, together with computer program code for performing the functions and actions of the embodiments herein. The program code mentioned above may also be provided as a computer program product, for instance in the form of a data carrier carrying computer program code for performing the embodiments herein when being loaded into the first RAN node 111. One such carrier may be in the form of a CD ROM disc. It is however feasible with other data carriers such as a memory stick. The computer program code may furthermore be provided as pure program code on a server and downloaded to the first RAN node 111.

The first RAN node 111 may further comprise respective a memory comprising one or more memory units. The memory comprises instructions executable by the processor in the first RAN node 111. The memory is arranged to be used to store instructions, data, configurations, and applications to perform the methods herein when being executed in the first RAN node 111.

In some embodiments, a computer program comprises instructions, which when executed by the at least one processor, cause the at least one processor of the first RAN node 111 to perform the actions above.

In some embodiments, a respective carrier comprises the respective computer program, wherein the carrier is one of an electronic signal, an optical signal, an electromagnetic signal, a magnetic signal, an electric signal, a radio signal, a microwave signal, or a computer-readable storage medium.

Those skilled in the art will also appreciate that the functional modules in the first RAN node 111, described below may refer to a combination of analog and digital circuits, and/or one or more processors configured with software and/or firmware, e.g., stored in the first RAN node 111, that when executed by the respective one or more processors such as the at least one processor described above cause the respective at least one processor to perform actions according to any of the actions above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

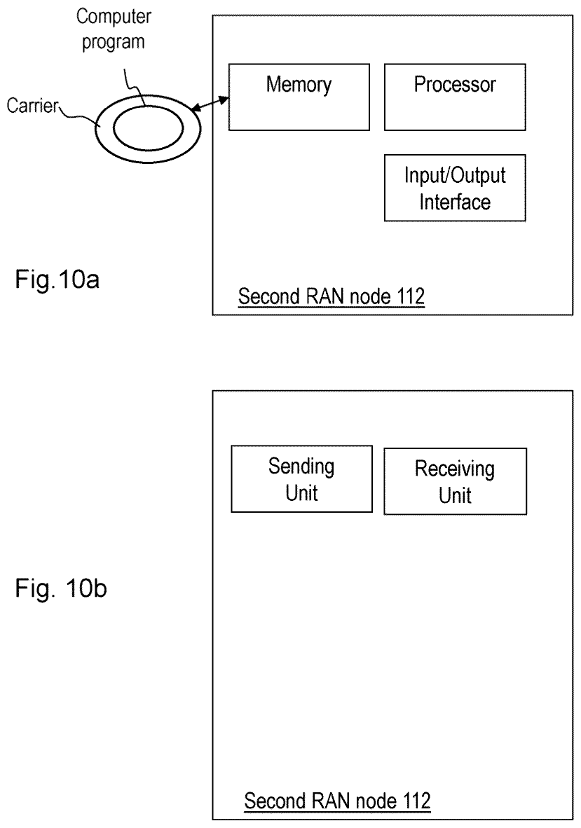

FIGS. 10a and 10b shows an example of arrangement in the second RAN node 112.

The second RAN node 112 may comprise an input and output interface configured to communicate with other networking entities in the wireless communications network 100, e.g., the first RAN node 111, the first CN node 131, and the second CN node 132. The input and output interface may comprise a receiver, e.g., wired and/or wireless, (not shown) and a transmitter, e.g., wired and/or wireless, (not shown).

The second RAN node 112 may comprise any one or more out of: An obtaining unit, a receiving unit to perform the method actions as described herein.

The embodiments herein may be implemented through a processor or one or more processors, such as at least one processor of a processing circuitry in the second RAN node 112 depicted in FIG. 10a, together with computer program code for performing the functions and actions of the embodiments herein. The program code mentioned above may also be provided as a computer program product, for instance in the form of a data carrier carrying computer program code for performing the embodiments herein when being loaded into the second RAN node 112. One such carrier may be in the form of a CD ROM disc. It is however feasible with other data carriers such as a memory stick. The computer program code may furthermore be provided as pure program code on a server and downloaded to the second RAN node 112.

The second RAN node 112 may further comprise respective a memory comprising one or more memory units. The memory comprises instructions executable by the processor in the second RAN node 112. The memory is arranged to be used to store instructions, data, configurations, and applications to perform the methods herein when being executed in the second RAN node 112.

In some embodiments, a computer program comprises instructions, which when executed by the at least one processor, cause the at least one processor of the second RAN node 112 to perform the actions above.

In some embodiments, a respective carrier comprises the respective computer program, wherein the carrier is one of an electronic signal, an optical signal, an electromagnetic signal, a magnetic signal, an electric signal, a radio signal, a microwave signal, or a computer-readable storage medium.

Those skilled in the art will also appreciate that the functional modules in the second RAN node 112, described below may refer to a combination of analog and digital circuits, and/or one or more processors configured with software and/or firmware, e.g., stored in the second RAN node 112, that when executed by the respective one or more processors such as the at least one processor described above cause the respective at least one processor to perform actions according to any of the actions above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

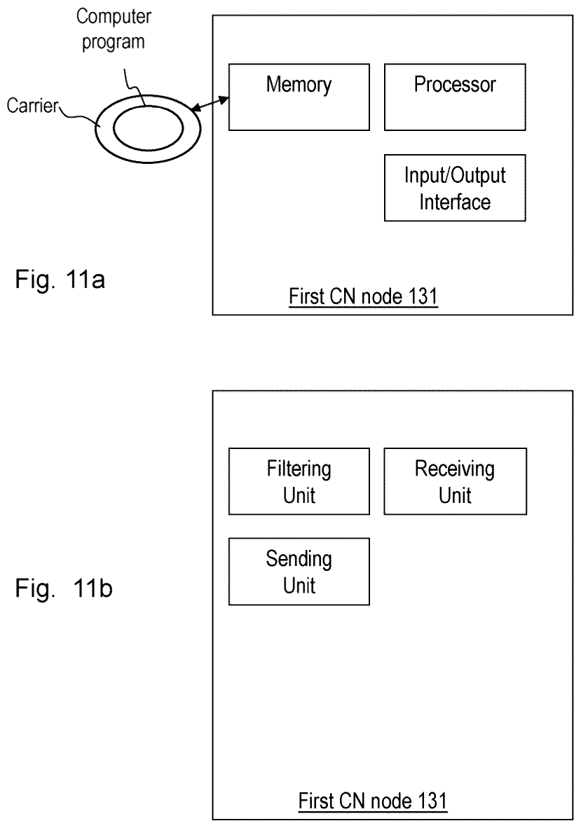

FIGS. 11a and 11b shows an example of arrangement in the first CN node 131.

The first CN node 131 may comprise an input and output interface configured to communicate with other networking entities in the wireless communications network 100, e.g., the first RAN node 111, the second RAN node 112, and the second CN node 132. The input and output interface may comprise a receiver, e.g., wired and/or wireless, (not shown) and a transmitter, e.g., wired and/or wireless, (not shown).

The first CN node 131 may comprise any one or more out of: An obtaining unit, a receiving unit, a filtering unit to perform the method actions as described herein.

The embodiments herein may be implemented through a processor or one or more processors, such as at least one processor of a processing circuitry in the first CN node 131 depicted in FIG. 11a, together with computer program code for performing the functions and actions of the embodiments herein. The program code mentioned above may also be provided as a computer program product, for instance in the form of a data carrier carrying computer program code for performing the embodiments herein when being loaded into the first CN node 131. One such carrier may be in the form of a CD ROM disc. It is however feasible with other data carriers such as a memory stick. The computer program code may furthermore be provided as pure program code on a server and downloaded to the first CN node 131.

The first CN node 131 may further comprise respective a memory comprising one or more memory units. The memory comprises instructions executable by the processor in the first CN node 131. The memory is arranged to be used to store instructions, data, configurations, and applications to perform the methods herein when being executed in the first CN node 131.

In some embodiments, a computer program comprises instructions, which when executed by the at least one processor, cause the at least one processor of the first CN node 131 to perform the actions above.

In some embodiments, a respective carrier comprises the respective computer program, wherein the carrier is one of an electronic signal, an optical signal, an electromagnetic signal, a magnetic signal, an electric signal, a radio signal, a microwave signal, or a computer-readable storage medium.

Those skilled in the art will also appreciate that the functional modules in the first CN node 131, described below may refer to a combination of analog and digital circuits, and/or one or more processors configured with software and/or firmware, e.g., stored in the first CN node 131, that when executed by the respective one or more processors such as the at least one processor described above cause the respective at least one processor to perform actions according to any of the actions above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

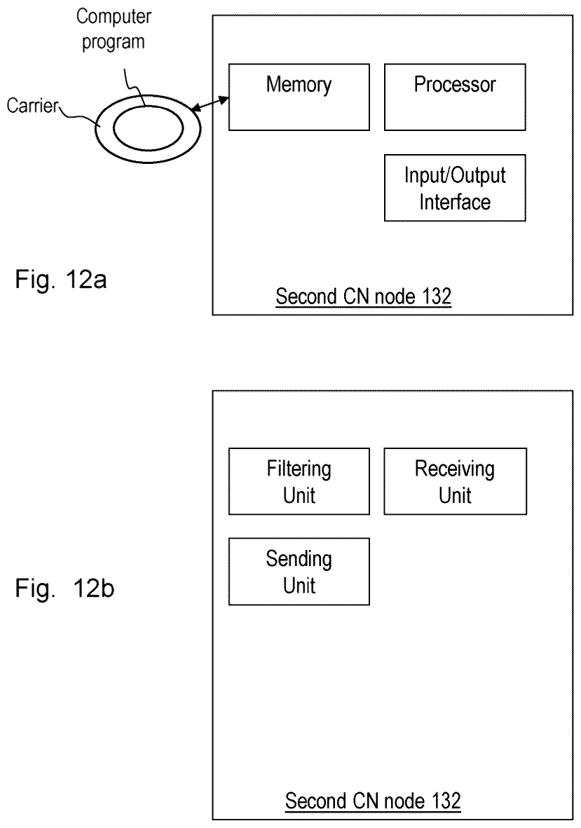

FIGS. 12a and 12b shows an example of arrangement in the second CN node 132.

The second CN node 132 may comprise an input and output interface configured to communicate with other networking entities in the wireless communications network 100, e.g., the first RAN node 111, the second RAN node 112, and the first CN node 131. The input and output interface may comprise a receiver, e.g., wired and/or wireless, (not shown) and a transmitter, e.g., wired and/or wireless, (not shown).

The second CN node 132 may comprise any one or more out of: An obtaining unit, a receiving unit, a filtering unit to perform the method actions as described herein.

The embodiments herein may be implemented through a processor or one or more processors, such as at least one processor of a processing circuitry in the second CN node 132 depicted in FIG. 12a, together with computer program code for performing the functions and actions of the embodiments herein. The program code mentioned above may also be provided as a computer program product, for instance in the form of a data carrier carrying computer program code for performing the embodiments herein when being loaded into the second CN node 132. One such carrier may be in the form of a CD ROM disc. It is however feasible with other data carriers such as a memory stick. The computer program code may furthermore be provided as pure program code on a server and downloaded to the second CN node 132.

The second CN node 132 may further comprise respective a memory comprising one or more memory units. The memory comprises instructions executable by the processor in the second CN node 132. The memory is arranged to be used to store instructions, data, configurations, and applications to perform the methods herein when being executed in the second CN node 132.

In some embodiments, a computer program comprises instructions, which when executed by the at least one processor, cause the at least one processor of the second CN node 132 to perform the actions above.

In some embodiments, a respective carrier comprises the respective computer program, wherein the carrier is one of an electronic signal, an optical signal, an electromagnetic signal, a magnetic signal, an electric signal, a radio signal, a microwave signal, or a computer-readable storage medium.

Those skilled in the art will also appreciate that the functional modules in the second CN node 132, described below may refer to a combination of analog and digital circuits, and/or one or more processors configured with software and/or firmware, e.g., stored in the second CN node 132, that when executed by the respective one or more processors such as the at least one processor described above cause the respective at least one processor to perform actions according to any of the actions above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

### Embodiments

Below, some example Embodiments 1-32 are shortly described. See e.g., FIGS. 2, 3, 4, 5, 6, 7, 8, 9a, 9b, 10a, 10b, 11a, 11b, 12a, and 12b.

Embodiment 1. A method performed by a first Radio Access Network, RAN node 111 for handling supported Information Elements, IEs, related to a procedure involving a number of network nodes, towards a second RAN node 112 in a wireless communications system 100, e.g., via a first Core Network, CN, node 131 serving the first RAN node 111 and a second CN node 132 serving the second RAN node 112, the method comprising any one or more out of:
sending 301 a first indication towards the second RAN node 112, which first indication indicates whether or not one or more first IEs, that are part of the procedure are supported by the first RAN node 111 during the procedure,
receiving 302 a response comprising a second indication from the second RAN node 112, which second indication indicates whether or not one or more second IEs that are part of the procedure are supported by the second RAN node 112 during the procedure, and e.g., further supported by any one or more out of: the first CN node 131 serving the first RAN node 111, a second CN node 132 serving the second RAN node 112 during the procedure.

Embodiment 2. The method according to Embodiment 1, wherein:
the first indication further indicates whether or not one or more first functionalities associated with the respective one or more first IEs that are part of the procedure, are supported by the first RAN node 111 during the procedure,
the second indication further indicates whether or not one or more second functionalities associated with the respective one or more second IEs that are part of the procedure, are supported by the second RAN node 112 during the procedure, and e.g., further supported by any one or more out of: a first CN node 131 serving the first RAN node 111, a second CN node 132 serving the second RAN node 112 during the procedure.

Embodiment 3. The method according to any of the Embodiments 1-2, wherein any one or more out of:
the one or more second IEs are selected among the one or more first IEs, and
the one or more second functionalities are selected among the one or more first functionalities.

Embodiment 4. The method according to any of the Embodiments 1-3, wherein:
the first indication sent 301 to the second RAN node 112, will be received by the second RAN node 112 as filtered based on whether one or more out of:
the one or more first IEs are supported by one or more intermediate nodes during the procedure, such as e.g., the first CN node 131 serving the first RAN node 111, and the second CN node 132 serving the second RAN node and/or
the one or more first functionalities associated with the respective one or more first IEs, are supported by one or more intermediate nodes during the procedure, such as e.g., the first CN node 131 serving the first RAN node 111, and the second CN node 132 serving the second RAN node.

Embodiment 5. A computer program comprising instructions, which when executed by a processor, causes the processor to perform actions according to any of the Embodiments 1-4.

Embodiment 6. A carrier comprising the computer program of Embodiment 5, wherein the carrier is one of an electronic signal, an optical signal, an electromagnetic signal, a magnetic signal, an electric signal, a radio signal, a microwave signal, or a computer-readable storage medium.

Embodiment 7. A method performed by a second Radio Access Network, RAN node 112 for handling supported Information Elements, IEs, related to a procedure involving a number of network nodes, from a first RAN node 111 towards the second RAN node 112 in a wireless communications system 100, e.g., via a first Core Network, CN, node 131 serving the first RAN node 111 and a second CN node 132 serving the second RAN node 112, the method comprising any one or more out of:
receiving 401 a first indication from the first RAN node 111, which first indication indicates whether or not one or more first IEs, that are part of the procedure are supported by the first RAN node 111 during the procedure,
sending 402 a response comprising a second indication towards the first RAN node 111, which second indication indicates whether or not one or more second IEs that are part of the procedure are supported by the second RAN node 112 during the procedure, and e.g., further supported by any one or more out of: the first CN node 131 serving the first RAN node 111, a second CN node 132 serving the second RAN node 112 during the procedure.

Embodiment 8. The method according to Embodiment 7, wherein:
the first indication further indicates whether or not one or more first functionalities associated with the respective one or more first IEs that are part of the procedure, are supported by the first RAN node 111 during the procedure, and
the second indication further indicates whether or not one or more second functionalities associated with the respective one or more second IEs that are part of the procedure, are supported by the second RAN node 112 during the procedure, and e.g., further supported by any one or more out of: a first CN node 131 serving the first RAN node 111, a second CN node 132 serving the second RAN node 112 during the procedure.

Embodiment 9. The method according to any of the Embodiments 7-8, wherein any one or more out of:
the one or more second IEs are selected among the one or more first IEs, and
the one or more second functionalities are selected among the one or more first functionalities.

Embodiment 10. The method according to any of the Embodiments 7-9, wherein:
the first indication received 401 from the first RAN node 111, will be received as filtered based on whether one or more out of: the one or more first IEs are supported by one or more intermediate nodes during the procedure, such as e.g., the first CN node 131 serving the first RAN node 111, and the second CN node 132 serving the second RAN node and/or the one or more first functionalities associated with the respective one or more first IEs, are supported by one or more intermediate nodes during the procedure, such as e.g., the first CN node 131 serving the first RAN node 111, and the second CN node 132 serving the second RAN node.

Embodiment 11. A computer program comprising instructions, which when executed by a processor, causes the processor to perform actions according to any of the Embodiments 7-10.

Embodiment 12. A carrier comprising the computer program of Embodiment 11, wherein the carrier is one of an electronic signal, an optical signal, an electromagnetic signal, a magnetic signal, an electric signal, a radio signal, a microwave signal, or a computer-readable storage medium.

Embodiment 13. A method performed by a first Core Network, CN, node 131 for handling supported Information Elements, IEs, related to a procedure involving a number of network nodes, from a first Radio Access Network, RAN, node 111 towards a second RAN node 112 in a wireless communications system 100, e.g., via the first CN node 131 serving the first RAN node 111 and a second CN node 132 serving the second RAN node 112, which first CN node 131 is serving the first RAN node 111, the method comprising any one or more out of:
receiving 501 a first indication from the first RAN node 111 sent towards the second RAN node 112, which first indication indicates whether or not one or more first IEs, that are part of the procedure are supported by the first RAN node 111 during the procedure,
filtering 502 the one or more first IEs comprised in the first indication based on whether the one or more first IEs are supported by the first CN node 131
sending 503 towards the second RAN node 112 the first indication as filtered, which first indication as filtered indicates whether or not one or more first IEs that are part of the procedure are supported by both the first RAN node 111 and the first CN node 131 during the procedure.

Embodiment 14. The method according to Embodiment 13, wherein the first indication further indicates whether or not one or more first functionalities associated with the respective one or more first IEs that are part of the procedure, are supported by the first RAN node 111 during the procedure, the method further comprising any one or more out of:
wherein the filtering 502 further filters the one or more first functionalities comprised in the first indication based on whether the one or more first functionalities are supported by the first CN node 131, and
wherein the sending 503 towards the second RAN node 112, the first indication as filtered, indicating whether or not the one or more first functionalities associated with the respective one or more first IEs are supported by both the first RAN node 111 and the first CN node 131 during the procedure.

Embodiment 15. A computer program comprising instructions, which when executed by a processor, causes the processor to perform actions according to any of the Embodiments 13-14.

Embodiment 16. A carrier comprising the computer program of Embodiment 55, wherein the carrier is one of an electronic signal, an optical signal, an electromagnetic signal, a magnetic signal, an electric signal, a radio signal, a microwave signal, or a computer-readable storage medium.

Embodiment 17. A method performed by a second Core Network, CN, node 132 for handling supported Information Elements, IEs, related to a procedure involving a number of network nodes, from a first Radio Access Network, RAN, node 111 towards a second RAN node 112 in a wireless communications system 100, e.g., via a first CN node 131 serving the first RAN node 111 and the second CN node 132 serving the second RAN node 112, which second CN node 132 is serving the second RAN node 112, the method comprising any one or more out of:
receiving 601 from the first RAN node 111 sent towards the second RAN node 112 via a first CN node 131 serving the first RAN node 111, a first indication as first filtered by the first CN node 131, which first indication as first filtered indicates whether or not one or more first IEs that are part of the procedure are supported by both the first RAN node 111 and the first CN node 131 during the procedure,
further filtering 602 the one or more first IEs comprised in the received first indication as first filtered based on whether the one or more first IEs are supported by the second CN node 132, and
sending 603 towards the second RAN node 112, the first indication as further filtered by the second CN node 132 indicating whether or not the one or more first IEs are supported by the first RAN node 111, the first CN node 131 and the second CN node 132, during the procedure.

Embodiment 18. The method according to Embodiment 17, wherein the first indication as first filtered further indicates whether or not one or more first functionalities associated with the respective one or more first IEs are supported by both the first RAN node 111 and the first CN node 131 during the procedure, the method further comprising any one or more out of:
wherein the further filtering 602 of the one or more first IEs comprised in the received first indication as first filtered further is based on whether the one or more first functionalities are supported by the second CN node 132, and
wherein the sending 603 towards the second RAN node 112, the first indication as further filtered, indicates whether or not the one or more first functionalities associated with the respective one or more first IEs are supported by the first RAN node 112, the first CN node 131 and the second CN node 132, during the procedure.

Embodiment 19. A computer program comprising instructions, which when executed by a processor, causes the processor to perform actions according to any of the Embodiments 17-18.

Embodiment 20. A carrier comprising the computer program of Embodiment 19, wherein the carrier is one of an electronic signal, an optical signal, an electromagnetic signal, a magnetic signal, an electric signal, a radio signal, a microwave signal, or a computer-readable storage medium.

Embodiment 21. A first Radio Access Network, RAN node 111 configured to handle supported Information Elements, IEs, related to a procedure involving a number of network nodes, towards a second RAN node 112 in a wireless communications system 100, e.g., via a first Core Network, CN, node 131 serving the first RAN node 111 and a second CN node 132 serving the second RAN node 112, the first RAN node 111 further being configured to e.g., any one or more out of:
send, e.g., by means of a sending unit comprised in the first RAN node 111, a first indication towards the second RAN node 112, which first indication is adapted to indicate whether or not one or more first IEs, that are part of the procedure are supported by the first RAN node 111 during the procedure,
receive, e.g., by means of a receiving unit comprised in the first RAN node 111, a response comprising a second indication from the second RAN node 112, which second indication is adapted to indicate whether or not one or more second IEs that are part of the procedure are supported by the second RAN node 112 during the procedure, and e.g., further supported by any one or more out of: the first CN node 131 serving the first RAN node 111, a second CN node 132 serving the second RAN node 112 during the procedure.

Embodiment 22. The first RAN node 111 according to Embodiment 21, wherein:
the first indication further is adapted to indicate whether or not one or more first functionalities associated with the respective one or more first IEs that are part of the procedure, are supported by the first RAN node 111 during the procedure,
the second indication further is adapted to indicate whether or not one or more second functionalities associated with the respective one or more second IEs that are part of the procedure, are supported by the second RAN node 112 during the procedure, and e.g., further supported by any one or more out of: a first CN node 131 serving the first RAN node 111, a second CN node 132 serving the second RAN node 112 during the procedure.

Embodiment 23. The first RAN node 111 according to any of the Embodiments 21-22, wherein any one or more out of:
the one or more second IEs are selected among the one or more first IEs, and
the one or more second functionalities are selected among the one or more first functionalities.

Embodiment 24. The first RAN node 111 according to any of the Embodiments 21-23, wherein:
the first indication sent, e.g., by means of the sending unit comprised in the first RAN node 111, to the second RAN node 112, will be received by the second RAN node 112 as filtered based on whether one or more out of: the one or more first IEs are supported by one or more intermediate nodes during the procedure, such as e.g., the first CN node 131 serving the first RAN node 111, and the second CN node 132 serving the second RAN node, and/or the one or more first functionalities associated with the respective one or more first IEs, are supported by one or more intermediate nodes during the procedure, such as e.g., the first CN node 131 serving the first RAN node 111, and the second CN node 132 serving the second RAN node.

Embodiment 25. A second Radio Access Network, RAN node 112 configured to handle supported Information Elements, IEs, related to a procedure involving a number of network nodes, from a first RAN node 111 towards the second RAN node 112 in a wireless communications system 100, e.g., via a first Core Network, CN, node 131 serving the first RAN node 111 and a second CN node 132 serving the second RAN node 112, the second RAN node 112 further being configured e.g., to any one or more out of:
receive, e.g., by means of a receiving unit comprised in the second RAN node 112, a first indication from the first RAN node 111, which first indication is adapted to indicate whether or not one or more first IEs, that are part of the procedure are supported by the first RAN node 111 during the procedure,
send, e.g., by means of a sending unit comprised in the second RAN node 112, a response comprising a second indication towards the first RAN node 111, which second indication is adapted to indicate whether or not one or more second IEs that are part of the procedure are supported by the second RAN node 112 during the procedure, and e.g., further supported by any one or more out of: the first CN node 131 serving the first RAN node 111, a second CN node 132 serving the second RAN node 112 during the procedure.

Embodiment 26. The second RAN node 112 according to Embodiment 25, wherein:
the first indication further is adapted to indicate whether or not one or more first functionalities associated with the respective one or more first IEs that are part of the procedure, are supported by the first RAN node 111 during the procedure, and
the second indication further is adapted to indicate whether or not one or more second functionalities associated with the respective one or more second IEs that are part of the procedure, are supported by the second RAN node 112 during the procedure, and e.g., further supported by any one or more out of: a first CN node 131 serving the first RAN node 111, a second CN node 132 serving the second RAN node 112 during the procedure.

Embodiment 27. The second RAN node 112 according to any of the Embodiments 25-26, wherein any one or more out of:
the one or more second IEs are selected among the one or more first IEs, and
the one or more second functionalities are selected among the one or more first functionalities.

Embodiment 28. The second RAN node 112 according to any of the Embodiments 25-27, wherein:
the first indication received, e.g., by means of the receiving unit comprised in the second RAN node 112, from the first RAN node 111, will be received as filtered based on whether one or more out of: the one or more first IEs are supported by one or more intermediate nodes during the procedure, such as e.g., the first CN node 131 serving the first RAN node 111, and the second CN node 132 serving the second RAN node, and/or the one or more first functionalities associated with the respective one or more first IEs, are supported by one or more intermediate nodes during the procedure, such as e.g., the first CN node 131 serving the first RAN node 111, and the second CN node 132 serving the second RAN node.

Embodiment 29. A first Core Network, CN, node 131 for handling supported Information Elements, IEs, related to a procedure involving a number of network nodes, from a first Radio Access Network, RAN, node 111 towards a second RAN node 112 in a wireless communications system 100, e.g., via the first CN node 131 serving the first RAN node 111 and a second CN node 132 serving the second RAN node 112, which first CN node 131 is serving the first RAN node 111, the first CN node 131 further being configured e.g., to any one or more out of:
receive, e.g., by means of a receiving unit comprised in the first CN node 131, a first indication from the first RAN node 111 sent towards the second RAN node 112, which first indication is adapted to indicate whether or not one or more first IEs, that are part of the procedure are supported by the first RAN node 111 during the procedure,
filter, e.g., by means of a filtering unit comprised in the first CN node 131, the one or more first IEs comprised in the first indication based on whether the one or more first IEs are supported by the first CN node 131
send, e.g., by means of a sending unit comprised in the first CN node 131, towards the second RAN node 112 the first indication as filtered, which first indication as filtered is adapted to indicate whether or not one or more first IEs that are part of the procedure are supported by both the first RAN node 111 and the first CN node 131 during the procedure.

Embodiment 30. The first CN node 131 according to Embodiment 29, wherein the first indication further is adapted to indicate whether or not one or more first functionalities associated with the respective one or more first IEs that are part of the procedure, are supported by the first RAN node 111 during the procedure, the first CN node 131 further being configured to any one or more out of:
wherein the first CN node 131 is configured to filter, e.g., by means of the filtering unit comprised in the first CN node 131, by filtering the one or more first functionalities comprised in the first indication based on whether the one or more first functions are supported by the first CN node 131, and
wherein the first CN node 131 is configured to send, e.g., by means of the sending unit comprised in the first CN node 131, towards the second RAN node 112, the first indication as filtered, which first indication as filtered is adapted to indicate whether or not the one or more first functionalities associated with the respective one or more first IEs are supported by both the first RAN node 111 and the first CN node 131 during the procedure.

Embodiment 31. A second Core Network, CN, node 132 for handling supported Information Elements, IEs, related to a procedure involving a number of network nodes, from a first Radio Access Network, RAN, node 111 towards a second RAN node 112 in a wireless communications system 100, e.g., via a first CN node 131 serving the first RAN node 111 and the second CN node 132 serving the second RAN node 112, which second CN node 132 is serving the second RAN node 112, the second CN node 132 further being configured e.g., to any one or more out of:
receive, e.g., by means of a receiving unit comprised in the second CN node 132, from the first RAN node 111 sent towards the second RAN node 112 via the first CN node 131 serving the first RAN node 111, a first indication as first filtered by the first CN node 131, which first indication as first filtered is adapted to indicate whether or not one or more first IEs that are part of the procedure are supported by both the first RAN node 111 and the first CN node 131 during the procedure,
further filter, e.g., by means of a filtering unit comprised in the second CN node 132, the one or more first IEs comprised in the received first indication as first filtered based on whether the one or more first IEs are supported by the second CN node 132, and
send, e.g., by means of a sending unit comprised in the second CN node 132, towards the second RAN node 112, the first indication as further filtered by the second CN node 132 indicating whether or not the one or more first IEs are supported by the first RAN node 111, the first CN node 131 and the second CN node 132, during the procedure.

Embodiment 32. The second CN node 132 according to Embodiment 31, wherein the first indication as first filtered further indicates whether or not one or more first functionalities associated with the respective one or more first IEs are supported by both the first RAN node 111 and the first CN node 131 during the procedure, the second CN node 132 further being configured to any one or more out of:
further filter, e.g., by means of the filtering unit comprised in the second CN node 132, by filtering the one or more first IEs comprised in the received first indication as first filtered further based on whether the one or more first functionalities are supported by the second CN node 132, and
send, e.g., by means of the sending unit comprised in the second CN node 132, towards the second RAN node 112, the first indication as further filtered, which first indication as further filtered is adapted to indicate whether or not the one or more first functionalities associated with the respective one or more first IEs are supported by the first RAN node 112, the first CN node 131 and the second CN node 132, during the procedure.

### Further Extensions and Variations

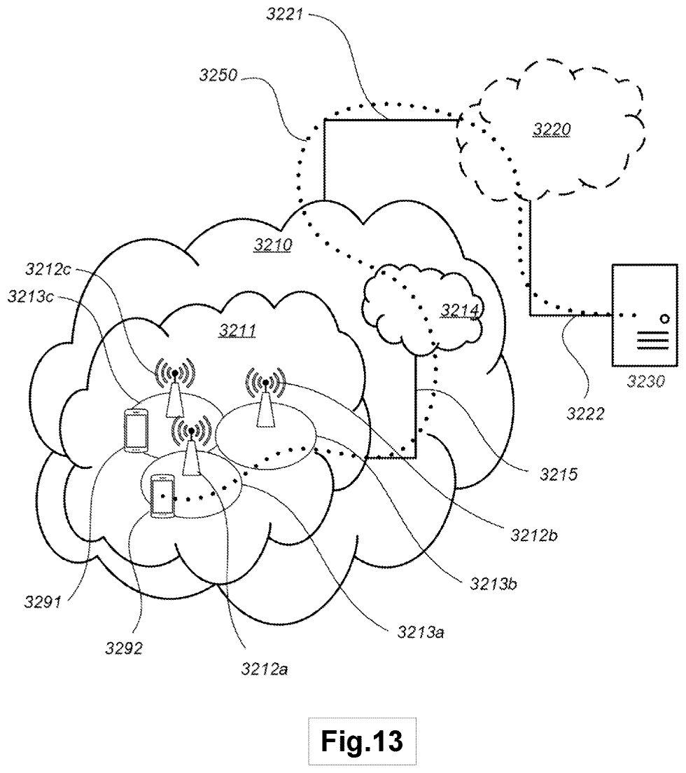

With reference to FIG. 13, in accordance with an embodiment, a communication system includes a telecommunication network 3210 such as the wireless communications network 100, e.g., an loT network, or a WLAN, such as a 3GPP-type cellular network, which comprises an access network 3211, such as a radio access network, and a core network 3214. The access network 3211 comprises a plurality of base stations 3212a, 3212b, 3212c, such as the first or second RAN node 111, 112, access nodes, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) e.g., the UE 120 such as a Non-AP STA 3291 located in coverage area 3213c is configured to wirelessly connect to, or be paged by, the corresponding base station 3212c. A second UE 3292 e.g., the UE 120 such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 13 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded e.g., handed over to a connected UE 3291. Similarly, the base station 3212 need not be aware of the future routing of an outgoing uplink communication originating from the UE 3291 towards the host computer 3230.

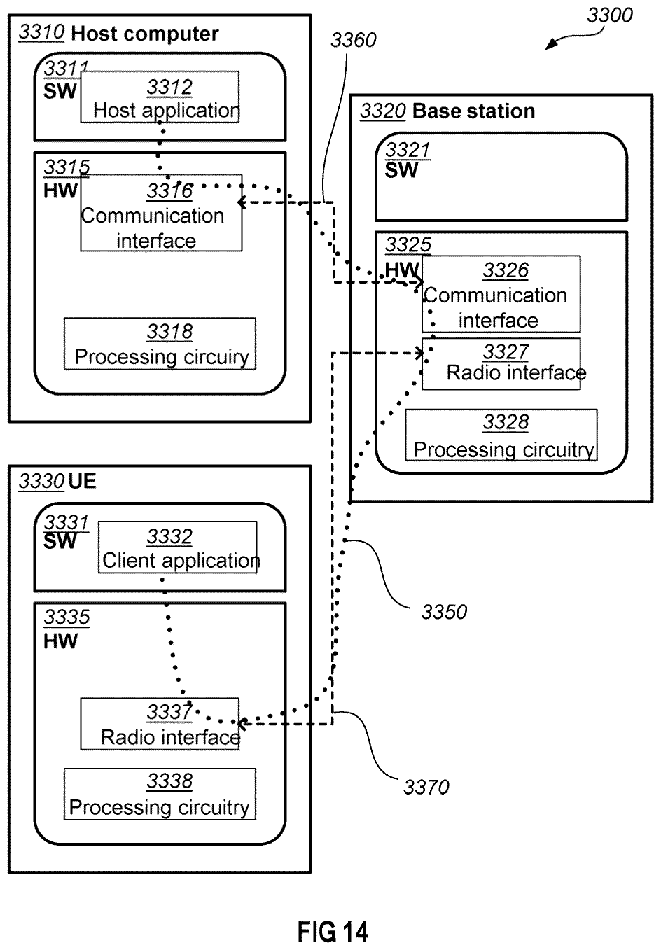

Example implementations, in accordance with an embodiment, of the UE, base station and host computer discussed in the preceding paragraphs will now be described with reference to FIG. 14. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown) served by the base station 3320. The communication interface 3326 may be configured to facilitate a connection 3360 to the host computer 3310. The connection 3360 may be direct or it may pass through a core network (not shown) in FIG. 14 of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 14 may be identical to the host computer 3230, one of the base stations 3212a, 3212b, 3212c and one of the UEs 3291, 3292 of FIG. 13, respectively. This is to say, the inner workings of these entities may be as shown in FIG. 14 and independently, the surrounding network topology may be that of FIG. 13.

In FIG. 14, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing e.g., on the basis of load balancing consideration or reconfiguration of the network.

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the applicable RAN effect: data rate, latency, power consumption, and thereby provide benefits such as corresponding effect on the OTT service: e.g., reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

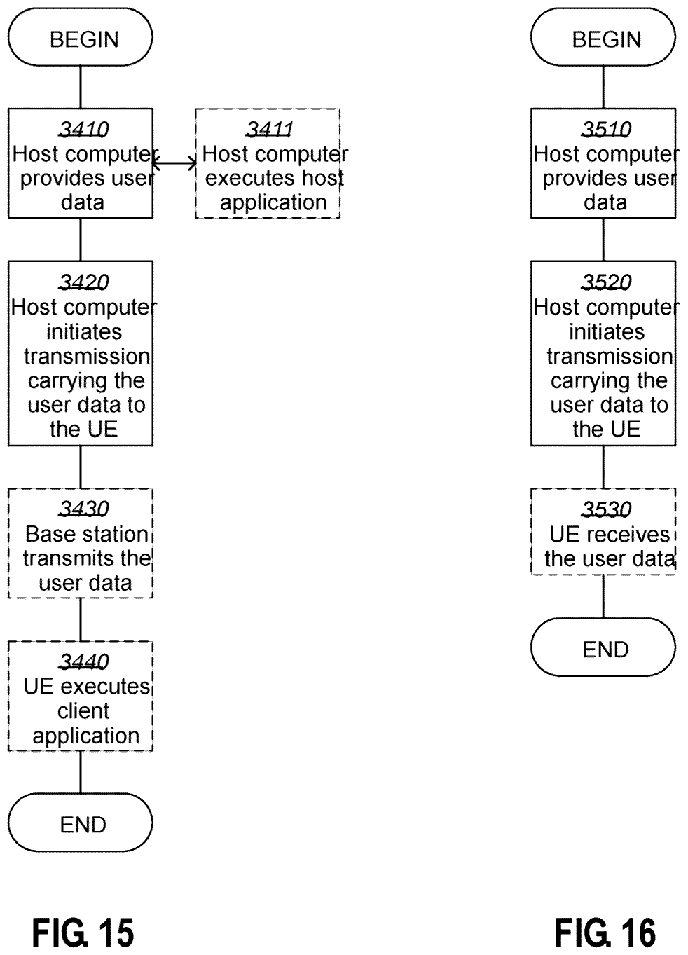

FIG. 15 is a flowchart illustrating a method implemented in a communication system, in accordance with one embodiment. The communication system includes a host computer, a base station such as the first or second RAN node 111, 112, and a UE such as the UE 120, which may be those described with reference to FIG. 13 and FIG. 14. For simplicity of the present disclosure, only drawing references to FIG. 15 will be included in this section. In a first action 3410 of the method, the host computer provides user data. In an optional sub action 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 16 is a flowchart illustrating a method implemented in a communication system, in accordance with one embodiment. The communication system includes a host computer, a base station such as an AP STA, and a UE such as a Non-AP STA which may be those described with reference to FIG. 13 and FIG. 14. For simplicity of the present disclosure, only drawing references to FIG. 16 will be included in this section. In a first action 3510 of the method, the host computer provides user data. In an optional sub action (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

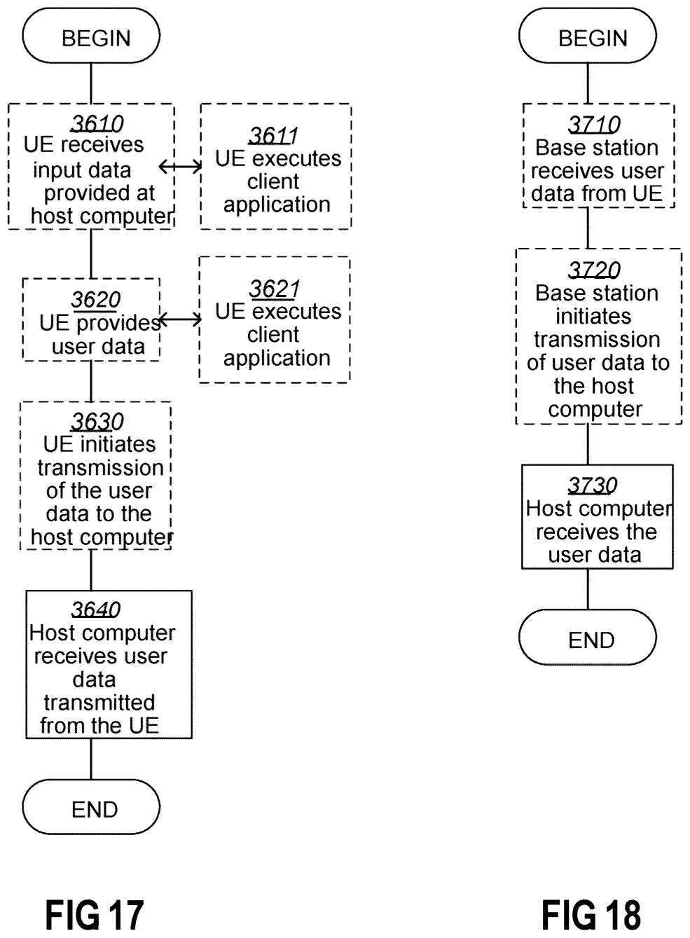

FIG. 17 is a flowchart illustrating a method implemented in a communication system, in accordance with one embodiment. The communication system includes a host computer, a base station such as an AP STA, and a UE such as a Non-AP STA which may be those described with reference to FIG. 13 and FIG. 14. For simplicity of the present disclosure, only drawing references to FIG. 17 will be included in this section. In an optional first action 3610 of the method, the UE receives input data provided by the host computer. Additionally or alternatively, in an optional second action 3620, the UE provides user data. In an optional sub action 3621 of the second action 3620, the UE provides the user data by executing a client application. In a further optional sub action 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third sub action 3630, transmission of the user data to the host computer. In a fourth action 3640 of the method, the host computer receives the user data transmitted from the UE, in accordance with the teachings of the embodiments described throughout this disclosure.

FIG. 18 is a flowchart illustrating a method implemented in a communication system, in accordance with one embodiment. The communication system includes a host computer, a base station such as an AP STA, and a UE such as a Non-AP STA which may be those described with reference to FIG. 13 and FIG. 14. For simplicity of the present disclosure, only drawing references to FIG. 18 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

Definitions of some abbreviations and acronyms used herein.

| Abbreviation | Explanation |
|---|---|
| AMF | Access and Mobility Management Function |
| MME | Mobility Management Entity |
| RAT | Radio Access technology |
| EPS | Evolved Packet System |
| 5GS | 5g System |
| HO | Handover |
| CN | Core Network |
| NW | Network |
| NAS | Non-Access Stratum |
| IAB | Integrated Access and Backhaul |

1. A method performed by a first Radio Access Network, RAN node (111) for handling supported Information Elements, IEs, related to a procedure involving a number of network nodes, towards a second RAN node (112) in a wireless communications system (100), the method comprising:
sending (301) a first indication towards the second RAN node (112), which first indication indicates whether or not one or more first IEs, that are part of the procedure are supported by the first RAN node (111) during the procedure,
receiving (302) a response comprising a second indication from the second RAN node (112), which second indication indicates whether or not one or more second IEs that are part of the procedure are supported by the second RAN node (112) during the procedure.

2. The method according to claim 1, wherein:
the first indication further indicates whether or not one or more first functionalities associated with the respective one or more first IEs that are part of the procedure, are supported by the first RAN node (111) during the procedure,
the second indication further indicates whether or not one or more second functionalities associated with the respective one or more second IEs that are part of the procedure, are supported by the second RAN node (112) during the procedure.

3. The method according to any of the claims 1-2, wherein any one or more out of:
the one or more second IEs are selected among the one or more first IEs, and
the one or more second functionalities are selected among the one or more first functionalities.

4. The method according to any of the claims 1-3, wherein:
the first indication sent (301) to the second RAN node (112), will be received by the second RAN node (112) as filtered based on whether one or more out of:
the one or more first IEs are supported by one or more intermediate nodes during the procedure, and/or
the one or more first functionalities associated with the respective one or more first IEs, are supported by one or more intermediate nodes during the procedure.

5. The method according to any of the claims 1-4, wherein the procedure involving a number of network nodes, towards the second RAN node 112 is performed via a first CN node (131) serving the first RAN node (111), and a second CN node (132) serving the second RAN node (112).

6. A computer program comprising instructions, which when executed by a processor, causes the processor to perform actions according to any of the claims 1-5.

7. A carrier comprising the computer program of claim 6, wherein the carrier is one of an electronic signal, an optical signal, an electromagnetic signal, a magnetic signal, an electric signal, a radio signal, a microwave signal, or a computer-readable storage medium.

8. A method performed by a second Radio Access Network, RAN node (112) for handling supported Information Elements, IEs, related to a procedure involving a number of network nodes, from a first RAN node (111) towards the second RAN node (112) in a wireless communications system (100), the method comprising any one or more out of:
receiving (401) a first indication from the first RAN node (111), which first indication indicates whether or not one or more first IEs, that are part of the procedure are supported by the first RAN node (111) during the procedure,
sending (402) a response comprising a second indication towards the first RAN node (111), which second indication indicates whether or not one or more second IEs that are part of the procedure are supported by the second RAN node (112) during the procedure.

9. The method according to claim 8, wherein:
the first indication further indicates whether or not one or more first functionalities associated with the respective one or more first IEs that are part of the procedure, are supported by the first RAN node (111) during the procedure, and
the second indication further indicates whether or not one or more second functionalities associated with the respective one or more second IEs that are part of the procedure, are supported by the second RAN node (112) during the procedure.

10. The method according to any of the claims 8-9, wherein any one or more out of:
the one or more second IEs are selected among the one or more first IEs, and
the one or more second functionalities are selected among the one or more first functionalities.

11. The method according to any of the claims 8-10, wherein:
the first indication received (401) from the first RAN node (111), will be received as filtered based on whether one or more out of: the one or more first IEs are supported by one or more intermediate nodes during the procedure, and/or the one or more first functionalities associated with the respective one or more first IEs, are supported by one or more intermediate nodes during the procedure.

12. The method according to any of the claims 8-11, wherein the procedure involving a number of network nodes, towards the second RAN node 112 is performed via a first CN node (131) serving the first RAN node (111), and a second CN node (132) serving the second RAN node (112).

13. A computer program comprising instructions, which when executed by a processor, causes the processor to perform actions according to any of the claims 8-12.

14. A carrier comprising the computer program of claim 13, wherein the carrier is one of an electronic signal, an optical signal, an electromagnetic signal, a magnetic signal, an electric signal, a radio signal, a microwave signal, or a computer-readable storage medium.

15. A method performed by a first Core Network, CN, node (131) for handling supported Information Elements, IEs, related to a procedure involving a number of network nodes, from a first Radio Access Network, RAN, node (111) towards a second RAN node (112) in a wireless communications system (100), which first CN node (131) is serving the first RAN node (111), the method comprising:
receiving (501) a first indication from the first RAN node (111) sent towards the second RAN node (112), which first indication indicates whether or not one or more first IEs, that are part of the procedure are supported by the first RAN node (111) during the procedure,
filtering (502) the one or more first IEs comprised in the first indication based on whether the one or more first IEs are supported by the first CN node (131)
sending (503) towards the second RAN node (112) the first indication as filtered, which first indication as filtered indicates whether or not one or more first IEs that are part of the procedure are supported by both the first RAN node (111) and the first CN node (131) during the procedure.

16. The method according to claim 15, wherein the first indication further indicates whether or not one or more first functionalities associated with the respective one or more first IEs that are part of the procedure, are supported by the first RAN node (111) during the procedure, the method further comprising any one or more out of:
wherein the filtering (502) further filters the one or more first functionalities comprised in the first indication based on whether the one or more first functionalities are supported by the first CN node (131), and
wherein the sending (503) towards the second RAN node (112), the first indication as filtered, indicating whether or not the one or more first functionalities associated with the respective one or more first IEs are supported by both the first RAN node (111) and the first CN node (131) during the procedure.

17. A computer program comprising instructions, which when executed by a processor, causes the processor to perform actions according to any of the claims 15-16.

18. A carrier comprising the computer program of claim 17, wherein the carrier is one of an electronic signal, an optical signal, an electromagnetic signal, a magnetic signal, an electric signal, a radio signal, a microwave signal, or a computer-readable storage medium.

19. A method performed by a second Core Network, CN, node (132) for handling supported Information Elements, IEs, related to a procedure involving a number of network nodes, from a first Radio Access Network, RAN, node (111) towards a second RAN node (112) in a wireless communications system (100), which second CN node (132) is serving the second RAN node (112), the method comprising:
receiving (601) from the first RAN node (111) sent towards the second RAN node (112) via a first CN node (131) serving the first RAN node (111), a first indication as first filtered by the first CN node (131), which first indication as first filtered indicates whether or not one or more first IEs that are part of the procedure are supported by both the first RAN node (111) and the first CN node (131) during the procedure,
further filtering (602) the one or more first IEs comprised in the received first indication as first filtered based on whether the one or more first IEs are supported by the second CN node (132), and
sending (603) towards the second RAN node (112), the first indication as further filtered by the second CN node (132) indicating whether or not the one or more first IEs are supported by the first RAN node (111), the first CN node (131) and the second CN node (132), during the procedure.

20. The method according to claim 19, wherein the first indication as first filtered further indicates whether or not one or more first functionalities associated with the respective one or more first IEs are supported by both the first RAN node (111) and the first CN node (131) during the procedure, the method further comprising:
wherein the further filtering (602) of the one or more first IEs comprised in the received first indication as first filtered further is based on whether the one or more first functionalities are supported by the second CN node (132), and
wherein the sending (603) towards the second RAN node (112), the first indication as further filtered, indicates whether or not the one or more first functionalities associated with the respective one or more first IEs are supported by the first RAN node (112), the first CN node (131) and the second CN node (132), during the procedure.

21. A computer program comprising instructions, which when executed by a processor, causes the processor to perform actions according to any of the claims 19-20.

22. A carrier comprising the computer program of claim 21, wherein the carrier is one of an electronic signal, an optical signal, an electromagnetic signal, a magnetic signal, an electric signal, a radio signal, a microwave signal, or a computer-readable storage medium.

23. A first Radio Access Network, RAN node (111) configured to handle supported Information Elements, IEs, related to a procedure involving a number of network nodes, towards a second RAN node (112) in a wireless communications system (100), the first RAN node (111) further being configured to:
send a first indication towards the second RAN node (112), which first indication is adapted to indicate whether or not one or more first IEs, that are part of the procedure are supported by the first RAN node (111) during the procedure,
receive a response comprising a second indication from the second RAN node (112), which second indication is adapted to indicate whether or not one or more second IEs that are part of the procedure are supported by the second RAN node (112) during the procedure.

24. The first RAN node (111) according to claim 23, wherein:
the first indication further is adapted to indicate whether or not one or more first functionalities associated with the respective one or more first IEs that are part of the procedure, are supported by the first RAN node (111) during the procedure,
the second indication further is adapted to indicate whether or not one or more second functionalities associated with the respective one or more second IEs that are part of the procedure, are supported by the second RAN node (112) during the procedure.

25. The first RAN node (111) according to any of the claims 23-24, wherein any one or more out of:
the one or more second IEs are selected among the one or more first IEs, and
the one or more second functionalities are selected among the one or more first functionalities.

26. The first RAN node (111) according to any of the claims 23-25, wherein:
the first indication sent to the second RAN node (112), will be received by the second RAN node (112) as filtered based on whether one or more out of: the one or more first IEs are supported by one or more intermediate nodes during the procedure, and/or the one or more first functionalities associated with the respective one or more first IEs, are supported by one or more intermediate nodes during the procedure.

27. The first RAN node (111) according to any of the claims 23-26, wherein the procedure involving a number of network nodes, towards the second RAN node 112 is adapted to be performed via a first CN node (131) serving the first RAN node (111), and a second CN node (132) serving the second RAN node (112).

28. A second Radio Access Network, RAN node (112) configured to handle supported Information Elements, IEs, related to a procedure involving a number of network nodes, from a first RAN node (111) towards the second RAN node (112) in a wireless communications system (100), the second RAN node (112) further being configured to:
receive a first indication from the first RAN node (111), which first indication is adapted to indicate whether or not one or more first IEs, that are part of the procedure are supported by the first RAN node (111) during the procedure,
send a response comprising a second indication towards the first RAN node (111), which second indication is adapted to indicate whether or not one or more second IEs that are part of the procedure are supported by the second RAN node (112) during the procedure.

29. The second RAN node (112) according to claim 28, wherein:
the first indication further is adapted to indicate whether or not one or more first functionalities associated with the respective one or more first IEs that are part of the procedure, are supported by the first RAN node (111) during the procedure, and
the second indication further is adapted to indicate whether or not one or more second functionalities associated with the respective one or more second IEs that are part of the procedure, are supported by the second RAN node (112) during the procedure.

30. The second RAN node (112) according to any of the claims 28-29, wherein any one or more out of:
the one or more second IEs are selected among the one or more first IEs, and
the one or more second functionalities are selected among the one or more first functionalities.

31. The second RAN node (112) according to any of the claims 28-30, wherein:
the first indication received from the first RAN node (111), will be received as filtered based on whether one or more out of: the one or more first IEs are supported by one or more intermediate nodes during the procedure, and/or the one or more first functionalities associated with the respective one or more first IEs, are supported by one or more intermediate nodes during the procedure.

32. The second RAN node (112) according to any of the claims 28-31, wherein the procedure involving a number of network nodes, towards the second RAN node 112 is adapted to be performed via a first CN node (131) serving the first RAN node (111), and a second CN node (132) serving the second RAN node (112).

33. A first Core Network, CN, node (131) configured to handle supported Information Elements, IEs, related to a procedure involving a number of network nodes, from a first Radio Access Network, RAN, node (111) towards a second RAN node (112) in a wireless communications system (100), which first CN node (131) is serving the first RAN node (111), the first CN node (131) further being configured to:
receive a first indication from the first RAN node (111) sent towards the second RAN node (112), which first indication is adapted to indicate whether or not one or more first IEs, that are part of the procedure are supported by the first RAN node (111) during the procedure,
filter the one or more first IEs comprised in the first indication based on whether the one or more first IEs are supported by the first CN node (131), and
send towards the second RAN node (112) the first indication as filtered, which first indication as filtered is adapted to indicate whether or not one or more first IEs that are part of the procedure are supported by both the first RAN node (111) and the first CN node (131) during the procedure.

34. The first CN node (131) according to claim 33, wherein the first indication further is adapted to indicate whether or not one or more first functionalities associated with the respective one or more first IEs that are part of the procedure, are supported by the first RAN node (111) during the procedure, the first CN node (131) further being configured to:
wherein the first CN node (131) is configured to filter, e.g. by means of the filtering unit comprised in the first CN node (131), by filtering the one or more first functionalities comprised in the first indication based on whether the one or more first functionalities are supported by the first CN node (131), and
wherein the first CN node (131) is configured to send, e.g. by means of the sending unit comprised in the first CN node (131), towards the second RAN node (112), the first indication as filtered, which first indication as filtered is adapted to indicate whether or not the one or more first functionalities associated with the respective one or more first IEs are supported by both the first RAN node (111) and the first CN node (131) during the procedure.

35. A second Core Network, CN, node (132) configured to handle supported Information Elements, IEs, related to a procedure involving a number of network nodes, from a first Radio Access Network, RAN, node (111) towards a second RAN node (112) in a wireless communications system (100) which second CN node (132) is serving the second RAN node (112), the second CN node (132) further being configured to:
receive from the first RAN node (111), sent towards the second RAN node (112) via the first CN node (131) serving the first RAN node (111), a first indication as first filtered by the first CN node (131), which first indication as first filtered is adapted to indicate whether or not one or more first IEs that are part of the procedure are supported by both the first RAN node (111) and the first CN node (131) during the procedure,
further filter the one or more first IEs comprised in the received first indication as first filtered based on whether the one or more first IEs are supported by the second CN node (132), and
send towards the second RAN node (112), the first indication as further filtered by the second CN node (132) indicating whether or not the one or more first IEs are supported by the first RAN node (111), the first CN node (131) and the second CN node (132), during the procedure.

36. The second CN node (132) according to claim 35, wherein the first indication as first filtered further indicates whether or not one or more first functionalities associated with the respective one or more first IEs are supported by both the first RAN node (111) and the first CN node (131) during the procedure, the second CN node (132) further being configured to any one or more out of:
further filter by filtering the one or more first IEs comprised in the received first indication as first filtered further based on whether the one or more first functionalities are supported by the second CN node (132), and
send, towards the second RAN node (112), the first indication as further filtered, which first indication as further filtered is adapted to indicate whether or not the one or more first functionalities associated with the respective one or more first IEs are supported by the first RAN node (112), the first CN node (131) and the second CN node (132), during the procedure.
